(19) United States
(12) Patent Application Publication
(10) Pub. No.: US 2026/0257826 A1
(43) Pub. Date: Sep. 3, 2026

(54) LABEL WRAPPING DEVICE ADJUSTING LABEL-STOPPING-POSITION FOR WRAPPING LABEL AROUND TARGET OBJECT

(71) Applicant: BROTHER KOGYO KABUSHIKI KAISHA, Nagoya (JP)

(72) Inventors: Yoshimi IWAMOTO, Nagoya (JP); Masashi TANIZAKI, Kuwana (JP); Tomohiro WADA, Nagoya (JP); Ryuichi KANDA, Nagoya (JP); Yuya NAKAMURA, Nagoya (JP); Shota IIJIMA, Nagoya (JP)

(21) Appl. No.: 19/547,415

(22) Filed: Feb. 23, 2026

(30) Foreign Application Priority Data
Feb. 28, 2025 (JP) 2025-032454

(51) Int. Cl. B65C 3/02; B65C 9/18; B65C 9/26

(52) U.S. Cl. CPC B65C 3/02; B65C 9/1803; B65C 9/26

(57) ABSTRACT

A label wrapping device includes a wrapping assembly, and a controller. The controller stops conveyance of the label such that a downstream edge of the label is at a stopping position. The label crosses an object-insertion path in a state where the downstream edge is at the stopping position. After a target object has entered an interior space of the wrapping assembly along the object-insertion path, the controller wraps the label around the target object about a specific axis by rotating a rotary body of the wrapping assembly. When a dimension of the target object in a transverse direction perpendicular to the specific axis is a first dimension, the stopping position is set to a first position whereas when the dimension of the target object is a second dimension different from the first dimension, the stopping position is set to a second position different from the first position.

### REFERENCE TO RELATED APPLICATIONS

This application claims priority from Japanese Patent Application No. 2025-032454 filed on February 28, 2025. The entire content of the priority application is incorporated herein by reference.

### BACKGROUND ART

Label wrapping devices that wrap labels around rod-shaped members are known in the art. One such label wrapping device includes an opening/closing member, a guide member, a wrapping mechanism, a conveying roller, and a restriction part. The conveying roller conveys the label past the opening/closing member until the downstream edge of the label contacts the restriction part. The restriction part has a restriction wall that contacts the downstream edge of the label so that the label is not conveyed farther downstream. The opening/closing member and the guide member guide the rod-shaped member together with the label into the wrapping mechanism. The wrapping mechanism rotates to wrap the label around the rod-shaped member.

### SUMMARY

With the known label wrapping device, the wrapping operation is performed without taking into account the various types of rod-shaped member. Consequently, depending on the type of rod-shaped member the label may not adhere sufficiently to a target member. This could result in degraded wrapping quality when the wrapping mechanism wraps the label around the target member.

In view of the foregoing, it is an object of the present disclosure to provide a label wrapping device and a control program for the label wrapping device that ensure stable wrapping quality during operations for wrapping labels around a target object, regardless of the type of target object.

In order to attain the above and other objects, the present disclosure provides a label wrapping device. The label wrapping device includes a conveying roller, a wrapping assembly, and a controller. The wrapping assembly includes a rotary body. The wrapping assembly defines an opening and an interior space continuous with the opening. The controller includes one or more processors. The controller is configured to perform: conveying a label in a conveying direction using the conveying roller; stopping the conveying the label such that a downstream edge of the label in the conveying direction is located at a stopping position, the label crossing an object-insertion path in a state where the downstream edge is located at the stopping position, the object-insertion path extending to the opening; and wrapping, after a target object has entered the interior space along the object-insertion path subsequent to the stopping, the label around the target object about a specific axis by rotating the rotary body. When a dimension of the target object in a transverse direction perpendicular to the specific axis is a first dimension, the stopping position is set to a first position whereas when the dimension of the target object is a second dimension different from the first dimension, the stopping position is set to a second position different from the first position.

According to another aspects, the disclosure provides a non-transitory computer-readable storage medium storing instructions for an information processing device communicable with a label wrapping device configured to wrap a label around a target object about a specific axis. The instructions, when executed in the information processing device, causes the information processing device to perform: obtaining dimension information related to a dimension of the target object in a transverse direction perpendicular to the specific axis; and transmitting position-related information to the label wrapping device, the position-related information being set based on the dimension information, the position-related information being related to a stopping position, the position-related information being for use by the label wrapping device to stop conveyance of the label such that a downstream edge of the label in a conveying direction of the label is located at the stopping position. When the dimension of the target object is a first dimension, the position-related information includes a first value whereas when the dimension of the target object is a second dimension different from the first dimension, the position-related information includes a second value different from the first value.

According to still another aspects, the disclosure provides a non-transitory computer-readable storage medium storing instructions for a label wrapping device. The instructions, when executed in the label wrapping device, causes the label wrapping device to perform: conveying a label in a conveying direction using a conveying roller of the label wrapping device; stopping the conveying the label such that a downstream edge of the label in the conveying direction is located at a stopping position, the label crossing an object-insertion path in a state where the downstream edge is located at the stopping position, the object-insertion path extending to an opening of a wrapping assembly of the label wrapping device; and wrapping, after a target object has entered an interior space of the wrapping assembly along the object-insertion path subsequent to the stopping, the label around the target object about a specific axis by rotating a rotary body of the wrapping assembly, the interior space being continuous with the opening. When a dimension of the target object in a transverse direction perpendicular to the specific axis is a first dimension, the stopping position is set to a first position whereas when the dimension of the target object is a second dimension different from the first dimension, the stopping position is set to a second position different from the first position.

In the above structures, the label wrapping device can perform a wrapping process while setting the stopping position based on the type of the target object. This configuration can ensure a stable wrapping quality when wrapping the label around the target object.

### BRIEF DESCRIPTION OF DRAWINGS

FIG. 1 is a perspective view of a label wrapping device.

FIG. 2 is a right-side cross section of a wrapping unit taken along a line I-I.

FIG. 3 is an enlarged portion of FIG. 2 around a rotary body of the wrapping unit.

FIG. 4 is an exploded perspective view of a main unit as viewed from a front upper right side.

FIG. 5 is a right-side cross section of the rotary body.

FIG. 6 is a block diagram illustrating an electric configuration of the label wrapping device.

FIGS. 7A-7C are illustrations showing a wrapping operation in a first wrapping mode.

FIGS. 8A-8C are illustrations showing the wrapping operation in a second wrapping mode.

FIGS. 9A-9D are illustrations showing rotational states of the rotary body when the label is wrapped around a cable.

FIGS. 10A and 10B are illustrations showing lengths of labels.

FIGS. 11A and 11B are illustrations showing label extensions.

FIGS. 12A-12C are illustrations showing a label length and printing position of the label when the diameter of a cable is less than a prescribed value.

FIGS. 13A-13C are illustrations showing a label length and printing position of the label when the diameter of a cable is greater than or equal to the prescribed value.

FIG. 14 is a block diagram illustrating an electrical configuration of a terminal device.

FIG. 15 is a flowchart illustrating a main process of an application program.

FIG. 16 is a flowchart illustrating a label wrapping process.

FIG. 17 is a flowchart illustrating a wrapping mode determination process.

### DESCRIPTION

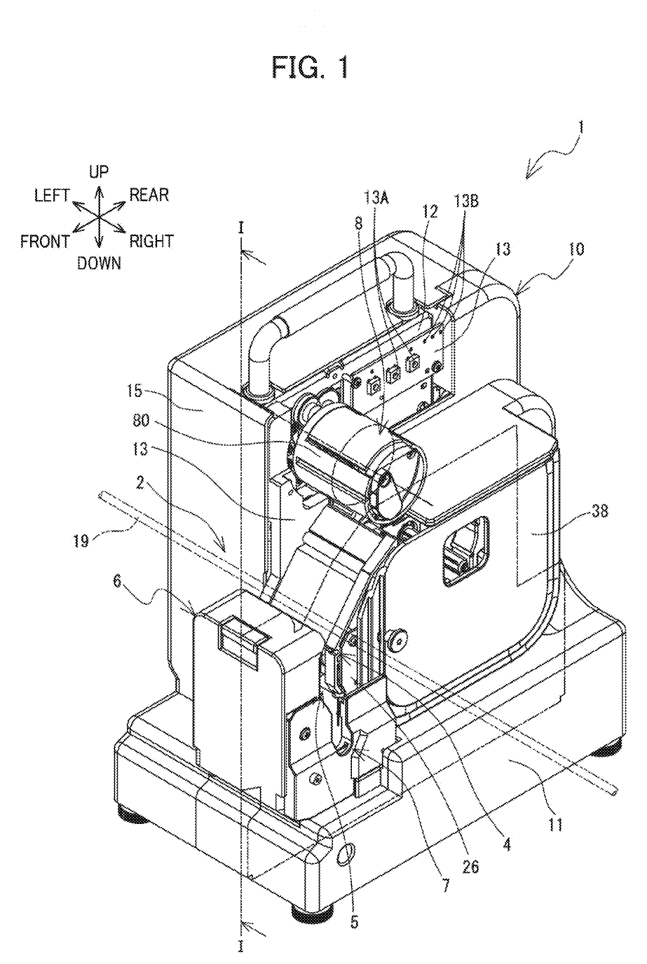

A label wrapping device 1 embodying the present disclosure will be described while referring to the accompanying drawings. The referenced drawings are used to describe the technical features made possible with the present disclosure. The configurations of devices shown in the drawings are merely illustrative examples, and the present disclosure is not intended to be limited to these configurations. Below, the lower left, upper right, upper left, lower right, top, and bottom of FIG. 1 are respectively defined as the front, rear, left, right, top, and bottom of the label wrapping device 1.

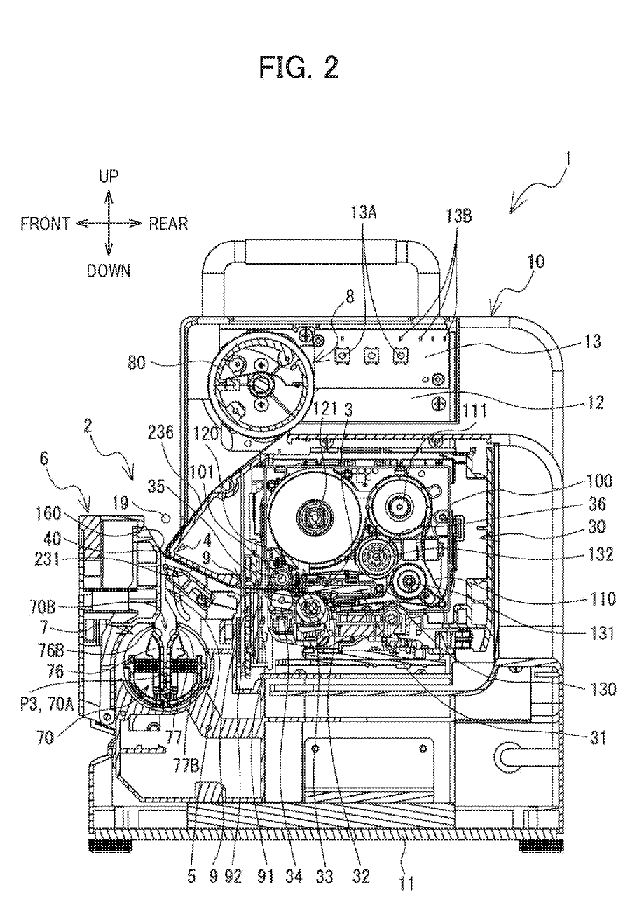

The label wrapping device 1 generates a label 160 by printing on a film tape 110 in a tape cassette 100. As shown in FIG. 2, the label wrapping device 1 is configured to wrap the generated label 160 around and affix the label 160 to a cable 19.

### Overview of the Label Wrapping Device 1

The label wrapping device 1 according to an embodiment of the present disclosure will be described with reference to FIGS. 1 and 2. The label wrapping device 1 has a box-shaped housing 10. The housing 10 has a base 11, a main unit 2, a main plate 12, a cover 15, a tape mounting unit 30, a print engine 3, and a cutting unit 9. The base 11 serves as the support stand of the label wrapping device 1. While not shown in the drawings, the base 11 houses a power supply board, and a battery.

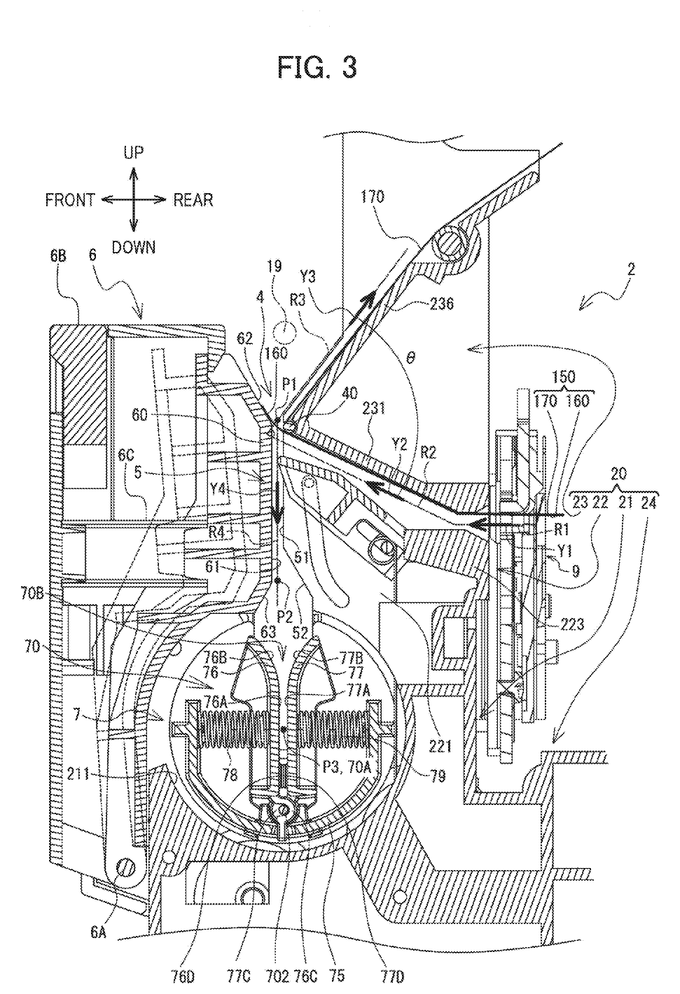

The main unit 2 has a peeling unit 4, a pressing unit 5, an opening/closing member 6, and a wrapping unit 7 described later. The base 11 holds the bottom end of the main unit 2. The main unit 2 peels the label 160 printed by the print engine 3 from a tape 150 (FIG. 3) and wraps the label 160 around the cable 19. The main unit 2 will be described later in greater detail.

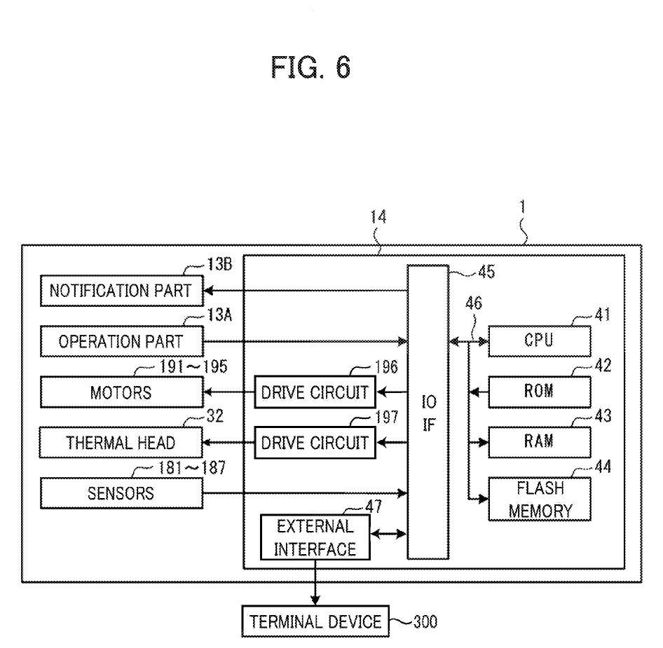

As shown in FIG. 2, the main plate 12 is a plate that extends in the up-down and front-rear directions. The lower end of the main plate 12 is fixed to the lower end of the main unit 2 inside the base 11. On the right side of the main plate 12, the main plate 12 supports the tape mounting unit 30, the print engine 3, the cutting unit 9, a take-up unit 8, and a control panel 13. On the left side of the main plate 12, the main plate 12 supports a control unit 14 shown in FIG. 6, and a drive unit (not shown). The control unit 14 controls the operations of the label wrapping device 1.

The upper end of the main plate 12 supports the control panel 13. The control panel 13 includes an operation part 13A that includes a plurality of buttons. The operation part 13A accepts input operations for the label wrapping device 1. The operation part 13A is a user interface or an input interface to receive an operation inputted by the user. The control panel 13 also includes a notification part 13B that includes a plurality of LEDs for indicating the operational status of the label wrapping device 1. The notification part 13B is also a user interface to notify the user of information. The label wrapping device 1 further includes a handle disposed on the upper end of the main plate 12 for use in carrying the label wrapping device 1. The cover 15 is disposed on the left side of the main plate 12 for protecting the control unit 14 and a gear set.

As shown in FIG. 2, the tape mounting unit 30 is disposed on the right side of the main plate 12 in the approximate front-rear and up-down center of the housing 10. The tape mounting unit 30 is box-shaped, with an open right side. Various tape cassettes including a thermal type, receptor type, and laminate type can be mounted in the tape mounting unit 30. The thermal type tape cassette houses thermal paper tape. The receptor type tape cassette houses tape and an ink ribbon. In this embodiment, a laminate type tape cassette 100 serves as an example of the tape cassette used in the label wrapping device 1. The tape cassette 100 is mounted in the tape mounting unit 30 through an opening that can be covered by a cassette cover 38 (FIG. 1).

The tape cassette 100 accommodates the film tape 110, a double-sided adhesive tape 120, and an ink ribbon 130. One example of the film tape 110 is a transparent PET (polyethylene terephthalate) tape. The film tape 110 is wound about a film spool 111. The double-sided adhesive tape 120 includes a base material, and a release material 170 (FIG. 3) that have been laminated together via an adhesive material. The double-sided adhesive tape 120 is wound about a tape spool 121. The ink ribbon 130 is wound about a ribbon spool 131. Used ink ribbon 130 is taken up on a take-up spool 132.

### Print engine 3

As shown in FIG. 2, the print engine 3 is positioned in the bottom section of the tape mounting unit 30. The print engine 3 includes a head holder 31, a thermal head 32, a platen roller 33, a conveying roller 34, a drive shaft 35, and a take-up shaft 36. The head holder 31 is a plate-shaped member that extends in the front-rear and left-right directions. The thermal head 32 is positioned on the bottom surface of the head holder 31. The thermal head 32 includes a plurality of heating elements. The heating elements are arranged in a row extending in the left-right direction.

The drive shaft 35 is located forward of the head holder 31. While the tape cassette 100 is mounted in the tape mounting unit 30, the drive shaft 35 is engaged in a shaft hole in a conveying roller 101 of the tape cassette 100. The drive shaft 35 drives the conveying roller 101 to convey the tape 150. The take-up shaft 36 is located diagonally above and rearward of the head holder 31. The take-up shaft 36 drives the take-up spool 132.

The platen roller 33 and conveying roller 34 are positioned below the head holder 31. The platen roller 33 presses the film tape 110 and ink ribbon 130 against the thermal head 32. The conveying roller 34 is positioned to the left of the platen roller 33. The conveying roller 34 overlays the film tape 110 on the double-sided adhesive tape 120 and presses both against the conveying roller 101. The conveying roller 101 conveys the film tape 110 and double-sided adhesive tape 120 nipped between the conveying roller 101 and the conveying roller 34.

During printing with the print engine 3, the platen roller 33 overlays the film tape 110 and ink ribbon 130 and presses both against the thermal head 32. The platen roller 33 rotates to convey the film tape 110 forward. The thermal head 32 generates heat to transfer ink from the ink ribbon 130 onto a printing surface of the film tape 110. As a result, an image containing objects such as characters is printed on the film tape 110. After printing, the ink ribbon 130 is separated from the film tape 110 and taken up on the take-up spool 132.

The double-sided adhesive tape 120 is overlaid on the printing surface of the printed film tape 110. The base material of the double-sided adhesive tape 120 contacts the printing surface of the film tape 110 from above. The film tape 110 and double-sided adhesive tape 120 pass between the conveying roller 101 and the conveying roller 34. The tape 150 includes the film tape 110 and the double-sided adhesive tape 120 in which the base material has been affixed to the film tape 110.

The cutting unit 9 is positioned to the front of the print engine 3. A conveying path R1 shown in FIG. 3 denotes the path along which the tape 150 is conveyed from the print engine 3 to the main unit 2 while passing through the cutting unit 9. The direction in which the tape 150 is conveyed along the conveying path R1 will be called a conveying direction Y1. The conveying direction Y1 is a forward direction leading from a position between the conveying rollers 101 and 34 to the main unit 2 while passing through the cutting unit 9.

### Cutting Unit 9

As shown in FIGS. 2 and 3, the cutting unit 9 is positioned downstream from the conveying roller 34 of the print engine 3 in the conveying direction Y1 of the tape 150. The cutting unit 9 has a full-cut cutting blade 91, and a half-cut cutting blade 92. The full-cut cutting blade 91 cuts the film tape 110, and the base material and release material 170 included in the double -sided adhesive tape 120, i.e., the tape 150. The half-cut cutting blade 92 cuts the film tape 110 and the base material of double-sided adhesive tape 120 while leaving the release material 170 intact. The label 160 includes the tape 150 after the release material 170 has been peeled off.

### Take-up Unit 8

The take-up unit 8 is located on the front and above of the main plate 12. The take-up unit 8 has a cylindrical reel 80. The reel 80 takes up the release material 170.

### Main Unit 2

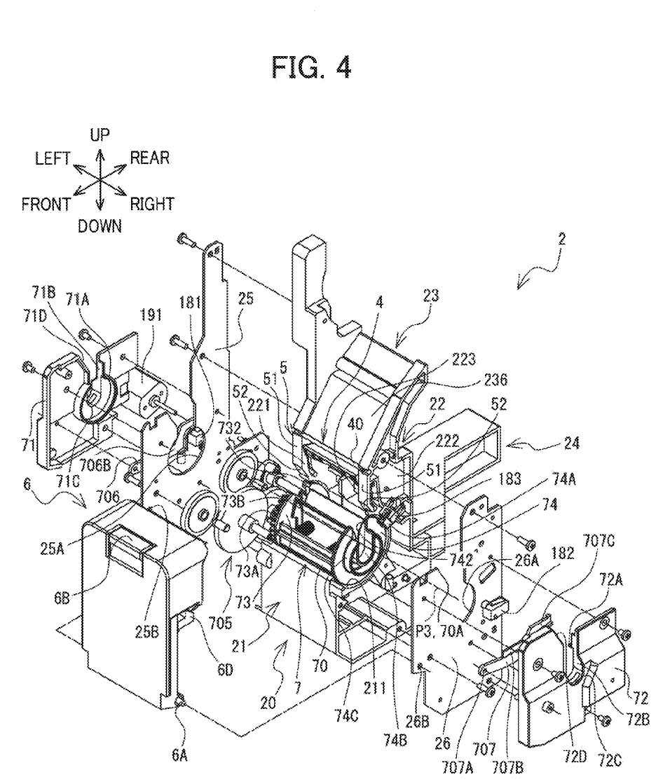

As shown in FIG. 4, the main unit 2 includes a base 20, a left plate 25 on the left side of the base 20, and a right plate 26 on the right side of the base 20. The base 20 has a lower portion 21, a middle portion 22, an upper portion 23, and a rear portion 24. The lower portion 21 is a box shaped member that opens at least at left and right sides and partially opens at the top and extends in the left-right direction. In other words, the lower portion 21 is a rectangular tube open at left and right sides and partially lacking the top wall. The peeling unit 4, pressing unit 5, opening/closing member 6, and wrapping unit 7 of the main unit 2 are disposed between the left plate 25 and right plate 26. The base 20 supports the entire main unit 2. The lower portion 21 includes the wrapping unit 7 for wrapping a label 160 around the cable 19.

The upper part of the lower portion 21 includes a housing part 211. The housing part 211 has a semicylindrical concave surface that is open on the top and front sides and has an axis aligned in the left-right direction. The housing part 211 houses the rotary body 70 that wraps labels 160 around cables 19. The rotary body 70 has a cylindrical shape. The rotary body 70 includes an external gear 73A and a left side portion 73. The external gear 73A is arranged on the left side portion 73. A drive mechanism 705 is arranged on the right side of the left plate 25 for driving the rotary body 70. The drive mechanism 705 drives the external gear 73A of the rotary body 70. The wrapping unit 7 has a motor 191 located on the left side of the left plate 25. The motor 191 drives the drive mechanism 705 to rotate the rotary body 70.

The middle portion 22 is located above the lower portion 21. The middle portion 22 has a left wall 221, a right wall 222, and a connecting wall 223. The left wall 221 extends upward from the rear end portion of the lower portion 21 on the left side of the lower portion 21. The right wall 222 extends upward from the rear end portion of the lower portion 21 on the right side of the lower portion 21. The connecting wall 223 connects the left wall 221 and right wall 222 in the left-right direction at a rear portion of the main unit 2. The peeling unit 4 is disposed in the area between the left wall 221 and the right wall 222. As shown in FIG. 3, as the cable 19 pulls the label 160 downward, the label 160 is peeled away from the release material 170 at the peeling unit 4 and moved downward together with the cable 19.

The pressing unit 5 is disposed on the middle portion 22 for pressing the end of the label 160 against the cable 19. The middle portion 22 has guide surfaces 51 on the front edges of the left wall 221 and right wall 222. The guide surfaces 51 extend in the up-down direction and face forward. The pressing unit 5 and the guide surfaces 51 will be described later. The middle portion 22 also has sloped surfaces 52 formed below the guide surfaces 51. After a label 160 has been wrapped around the cable 19 in the wrapping unit 7 and the cable 19 is moved upward to be removed from the label wrapping device 1, the sloped surfaces 52 guide the cable 19 into the gap between the guide surfaces 51 and a pressing surface 61 (FIG. 3) described later.

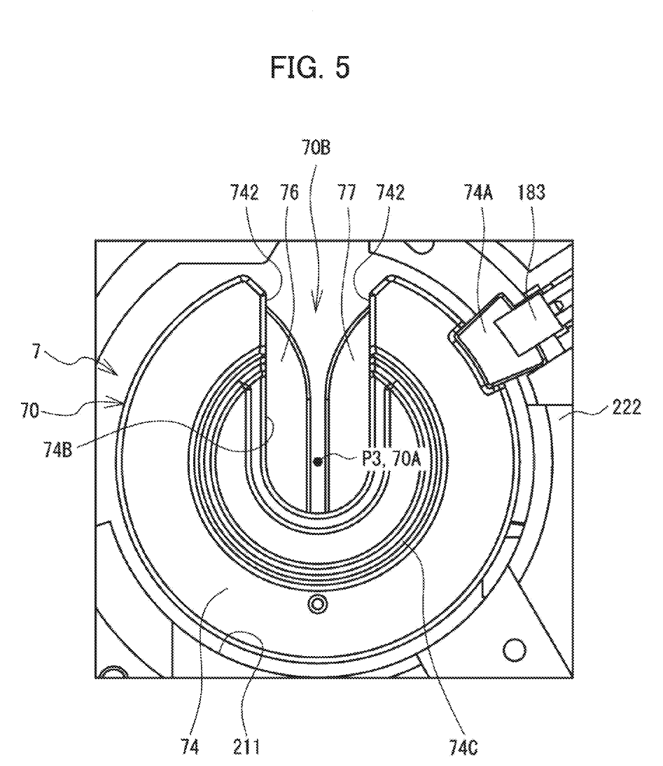

As shown in FIGS. 4 and 5, the right wall 222 supports a sensor 183. The sensor 183 detects a detection plate 74A. The detection plate 74 is disposed on a right side portion 74 of the rotary body 70. One example of the sensor 183 is a transmissive photosensor. The sensor 183 turns off when the detection plate 74A of the rotary body 70 blocks light traveling within the sensor 183 between a light-emitting element and a light-receiving element. The sensor 183 turns on when the detection plate 74A of the rotary body 70 no longer blocks light traveling within the sensor 183 between the light-emitting element and light-receiving element. Hereinafter, the sensor 183 will also be referred to as the “rotary body sensor 183.”

The upper portion 23 is located above the middle portion 22. The left wall 221 and right wall 222 each extends from the middle portion 22 to the upper portion 23. As shown in FIG. 3, the upper portion 23 has a first wall 231, and a second wall 236. The first wall 231 extends diagonally upward and forward. The second wall 236 extends diagonally upward and rearward from the front edge of the first wall 231. The peeling unit 4 is located at the junction between the first wall 231 and second wall 236. The peeling unit 4 will be described later.

The first wall 231 defines the portion of the conveying path R1 farthest downstream in the conveying direction Y1 (i.e., the portion of the conveying path R1 along which the tape 150 is conveyed after passing through the cutting unit 9), as well as a conveying path R2 for conveying the tape 150 toward the peeling unit 4. The conveying path R2 is continuous with the conveying path R1. A conveying direction Y2 denotes the direction in which the tape 150 is conveyed through the conveying path R2 along the first wall 231, and specifically is a direction diagonally upward and forward. The conveying path R2 guides the tape 150 toward the peeling unit 4. The second wall 236 defines a conveying path R3 for conveying the release material 170 toward the take-up unit 8.

After the print engine 3 prints an image on the tape 150, the tape 150 is conveyed along the conveying path R1 toward the cutting unit 9, with the label 160 positioned on the bottom of the release material 170. After the cutting unit 9 subsequently performs a half-cut in which the label 160 is cut off from the tape 150 by cutting the film 110 and base material of the tape 150 while leaving the release material 170 intact, the tape 150 is conveyed along the conveying path R2 while being taken up in a state of tension onto the take-up unit 8 positioned above the peeling unit 4.

As shown in FIG. 4, the left plate 25 is a metal plate extending in the up-down and front-rear directions. The left plate 25 is fixed to the left side of the base 20 with screws. The left plate 25 has a circular open area 25A that extends through the left plate 25 in the left-right direction. When the left plate 25 is assembled to the base 20, the circular portion of the open area 25A is aligned with the housing part 211 of the lower portion 21.

The right plate 26 is a metal plate extending in the up-down and front-rear directions. The right plate 26 is fixed to the right side of the base 20 with screws. The right plate 26 has a circular open area 26A that extends through the right plate 26 in the left-right direction. When the right plate 26 is assembled to the base 20, the circular portion of the open area 26A is aligned with the housing part 211 of the lower portion 21.

A left support part 71 is fixed to the left side of the left plate 25 with screws. The left support part 71 has a guide part 71B that is recessed downward from the top edge of the left support part 71. The guide part 71B has a U-shape. A bottom portion 71C of the guide part 71B is semicircular. The bottom portion 71C has an opening. An input part 706B of a lever member 706 (described later) is exposed through the opening. The bottom portion 71C of the guide part 71B positions the cable 19 in a wrapping position P3 (FIG. 5) with respect to the vertical direction at which the wrapping unit 7 wraps the label 160 around the cable 19. That is, the bottom portion 71C supports the cable 19 on the left side of the wrapping position P3. The guide part 71B guides the cable 19 into the bottom portion 71C.

The upper edge of the left support part 71 has a guide surface 71D that guides the cable 19 toward the guide part 71B. The guide surface 71D is a sloped surface that faces diagonally upward and rearward. The guide surface 71D contacts the cable 19 when the cable 19 is displaced forward after passing the pressing unit 5 along a guiding path R4 (FIG. 4) described later. Hence, the guide surface 71D guides the cable 19 toward the guide part 71B in order that the cable 19 reaches the wrapping unit 7.

A right support part 72 is fixed to the right side of the right plate 26 with screws. The right support part 72 has a guide part 72B that is recessed downward from the top edge of the right support part 72. The guide part 72B has a U-shape. A bottom portion 72C of the guide part 72B is semicircular in shape. The bottom portion 72C has an opening. An input part 707B of a lever member 707 described later is exposed through the opening. The bottom portion 72C of the guide part 72B positions the cable 19 in the wrapping position P3 with respect to the vertical direction (FIG. 5). The bottom portion 72C supports the cable 19 on the right side of the wrapping position P3. The guide part 72B guides the cable 19 into the bottom portion 72C.

The upper edge of the right support part 72 has a guide surface 72D that guides the cable 19 toward the guide part 72B. The guide surface 72D is a sloped surface facing diagonally upward and rearward. The guide surface 72D contacts the cable 19 when the cable 19 is displaced forward. Hence, the guide surface 72D guides the cable 19 to the guide part 72B.

The left side of the right support part 72 includes a rotary support 72A. A rotational shaft 74C (described later) of the rotary body 70 is engaged in the rotary support 72A. The inner surface of the rotary support 72A rotatably supports the rotational shaft 74C of the rotary body 70. The outer surface of the rotary support 72A is supported on the circular portion of the open area 26A of the right plate 26.

The left plate 25 supports a sensor 181. The right plate 26 supports a sensor 182. The sensors 181 and 182 are microswitches. The sensor 181 detects the cable 19 when the cable 19 has reached the bottom portion 71C of the left support part 71. The sensor 182 detects the cable 19 when the cable 19 has reached the bottom portion 72C of the right support part 72.

The mechanism for detecting the cable 19 with the sensor 182 will be described with reference to FIG. 4. The right support part 72 includes the lever member 707. The lever member 707 extends in the front-rear direction. In order from front to rear, the lever member 707 has a support part 707A, the input part 707B, and an operating part 707C. The support part 707A has the pivot point at which the lever member 707 is pivotably supported. A shaft protruding from the left surface of the right support part 72 is engaged in the support part 707A. A coil spring (not shown) urges the rear end of the lever member 707 upward.

The input part 707B is disposed on the top surface of an intermediate portion of the lever member 707 and protrudes upward from the intermediate portion. A portion of the input part 707B is exposed in the bottom portion 72C of the guide part 72B through the opening of the bottom portion 72C. The input part 707B causes the lever member 707 to pivot when pressed by the cable 19 that has been guided into the bottom portion 72C. While the input part 707B is exposed in the bottom portion 72C, the operating part 707C is positioned farther upward and rearward from the input part 707B and support part 707A.

The sensor 182 is fixed to the right surface of the right plate 26 at a position beneath the operating part 707C. The sensor 182 is a switch for driving a drive unit that rotates the rotary body 70. When the cable 19 presses the input part 707B downward, the operating part 707C in turn presses the sensor 182 downward, causing the sensor 182 to output an ON signal. The lever member 706 has the same configuration as the lever member 707. Since the lever member 706 performs the same function as the lever member 707 with respect to the sensor 181, a description of the lever member 706 has been omitted.

### Peeling Unit 4

As shown in FIG. 3, the peeling unit 4 is the part that peels the label 160 from the release material 170. The peeling unit 4 has a round rod-shaped peeling shaft 40 that extends in the left-right direction. The peeling shaft 40 is arranged at the junction between the first wall 231 and the second wall 236. In other words, the peeling shaft 40 is located at a position in the conveying path R2 farthest downstream in the conveying direction Y2 and a position in the conveying path R3 farthest upstream in a conveying direction Y3. As shown in FIG. 4, the peeling shaft 40 is exposed to the outside at the entry point of the guiding path R4. The guiding path R4 is defined by the guide surfaces 51 of the pressing unit 5 and the pressing surface 61 of the opening/closing member 6. The guiding path R4 may include (or pass through) an affixable position P1 (described later). In this case, the guiding path R4 is defined by the guide surfaces 51, the pressing surface 61, the support surface 62, and the peeling shaft 40. The affixable position P1 may be the entry point of the guiding path R4. The surface of the peeling shaft 40 has a coating layer that reduces the possibility that the adhesive material adheres to the peeling shaft 40 when the peeling shaft 40 peels off the label 160. The peeling shaft 40 may be a rotatably supported roller around which the release material 170 is peeled away from the label 160.

As shown in FIG. 3, an angle θ defined by the conveying direction Y2 and the conveying direction Y3 is 90 degrees or less. The take-up unit 8 shown in FIG. 2, pulls the release material 170 of the tape 150 conveyed along the conveying path R2 in the conveying direction Y3. Hence, at the peeling unit 4, the release material 170 is in contact with the peeling shaft 40 and bent at an angle of 90. Consequently, the edge of the label 160 in the tape 150 peels away from the release material 170. As the release material 170 moves in the conveying direction Y3, the edge of the label 160 that has peeled away from the release material 170 moves in the conveying direction Y2.

As a result, the leading edge of the label 160 rides up onto a support surface 62 of the opening/closing member 6. At this time, the label 160 is arranged in the affixable position P1, with its adhesive surface facing upward. The affixable position P1 is the position at which the end portion of the label 160 is affixed to the cable 19. The affixable position P1 is the position farthest upstream in a guiding direction Y4, which is the direction that the cable 19 is guided when inserted into the guiding path R4 of the pressing unit 5.

### Opening/Closing Member 6

As shown in FIGS. 3 and 4, the opening/closing member 6 is box-shaped and extends in the up-down direction. The opening/closing member 6 is disposed on the front side of the base 20. The opening/closing member 6 has a shaft 6A. The shaft 6A engages in shaft holes 25B and 26B positioned in the lower-front corners of the left plate 25 and right plate 26, respectively, and rotatably supports the opening/closing member 6. The opening/closing member 6 has hooks 6D that engage with the base 20. The hooks 6D are interlocked with an opening/closing button 6B disposed in the upper-front corner of the opening/closing member 6. The hooks 6D are disengaged from the base 20 by pressing the opening/closing button 6B. In this disengaged state, the upper end of the opening/closing member 6 can be rotated forward into an open state.

As shown in FIG. 3, the opening/closing member 6 has a pressing member 60 that protrudes rearward when the opening/closing member 6 is in a closed state. The pressing member 60 extends in the up-down direction. The bottom end of the pressing member 60 is supported by the shaft 6A. The pressing member 60 pivots about the shaft 6A such that the top end of the pressing member 60 moves in the front-rear direction. A compression coil spring 6C is disposed inside the opening/closing member 6 for urging the pressing member 60 rearward. The rear surface of the pressing member 60 constitutes the pressing surface 61. When the opening/closing member 6 is in the closed state, the pressing surface 61 extends in the up-down and left-right directions and faces rearward.

In response to the urging force of the compression coil spring 6C, the pressing surface 61 presses the leading end of the label 160 against the cable 19 being guided in the guiding direction Y4 through the guiding path R4 between the guide surfaces 51 and the pressing surface 61. Position P2 will denote the position in the guiding path R4 farthest downstream in the guiding direction Y4 defined by the pressing surface 61. The pressing member 60 also includes the support surface 62 and a sloped surface 63.

The support surface 62 connects to the upper edge of the pressing surface 61. When the cable 19 is moved to the affixable position P1, the support surface 62 guides the cable 19 with respect to its position in the front-rear direction. Moreover, the leading edge of the label 160 that has been peeled off the release material 170 rides up onto the support surface 62. Therefore, when the user affixes the end portion of the label 160 to the cable 19, the end portion of the label 160 is pinched between the support surface 62 and the cable 19, causing the label 160 to adhere to the cable 19. Further, when the outer diameter of the cable 19 is larger than the gap between the pressing surface 61 and the guide surfaces 51, the cable 19 contacts and pushes the support surface 62 to widen the gap between the pressing surface 61 and the guide surfaces 51.

The sloped surface 63 connects to the bottom edge of the pressing surface 61. When the cable 19 is drawn upward from the wrapping unit 7 after the label 160 has been wrapped around the cable 19, the sloped surface 63 guides the cable 19 into the gap between the pressing surface 61 and the guide surfaces 51. When the diameter of the cable 19 is larger than the gap between the pressing surface 61 and the guide surfaces 51, the cable 19 contacts and pushes the sloped surface 63 to widen the gap between the pressing surface 61 and the guide surfaces 51.

### Pressing Unit 5

The pressing unit 5 is the component that presses the end portion of the label 160 against the cable 19 while guiding the cable 19 toward the wrapping unit 7 after the end portion of the label 160 has been affixed to the cable 19 at the affixable position P1. Therefore, pressing using the pressing unit 5 reduces the likelihood that the end of the label 160 peels off the cable 19.

### Wrapping Unit 7

When the cable 19 is disposed in the wrapping position P3 shown in FIGS. 3 and 5, the wrapping unit 7 wraps and attaches the label 160, whose end portion has been affixed to the cable 19, around the cable 19. As shown in FIGS. 2 through 5, the wrapping unit 7 has a cylindrical rotary body 70 having side surfaces that is partially missing. The rotary body 70 has a rotational axis 70A that is aligned with the wrapping position P3 shown in FIG. 3. The rotary body 70 is rotatably supported by the left support part 71 fixed to the left surface of the left plate 25, and the right support part 72 fixed to the right surface of the right plate 26. The rotary body 70 has the left side portion 73, the right side portion 74, and a circumferential portion 75 (FIG. 3).

The left side portion 73 and right side portion 74 are discs spaced apart and opposing each other in the left-right direction. The external gear 73A is disposed on the left surface of the left side portion 73. The external gear 73A meshes with the drive mechanism 705. The motor 191 drives the drive mechanism 705. The drive mechanism 705 rotates the rotary body 70.

The left side portion 73 has an insertion part 73B that is recessed toward the rotational axis 70A from the peripheral edge of the left side portion 73. The insertion part 73B has a general U-shape. The left side portion 73 has a C-shaped rotational shaft that protrudes leftward. The rotational shaft of the left side portion 73 follows the entire circumference of the left side portion 73, excluding the insertion part 73B, and is arranged radially inward of the external gear 73A toward the rotational axis 70A. The rotational shaft of the left side portion 73 engages in a rotary support 71A in the right surface of the left support part 71 and is rotatably supported in the rotary support 71A.

As shown in FIGS. 4 and 5, the right side portion 74 has the detection plate 74A on a peripheral edge of the right surface of the right side portion 74. The detection plate 74A is arranged in a position that can be detected by the rotary body sensor 183 when the rotary body 70 is in an initial position. The rotary body 70 can be halted in this initial position by performing control to halt rotation of the rotary body 70 when the rotary body sensor 183 detects the detection plate 74A. The initial position of the rotary body 70 is the position at which openings 732 and 742 are open upward, as shown in FIGS. 4 and 5. Hence, when the rotary body 70 is in the initial position, the cable 19 and label 160 can be inserted into insertion parts 73B and 74B.

The rotary body sensor 183 is disposed on the lower portion 21 of the base 20 to the upper rear of the housing part 211. The right side portion 74 has an insertion part 74B (FIG. 5) that is recessed toward the rotational axis 70A from the peripheral edge of the right side portion 74. The insertion part 74B has a U-shape. The right side portion 74 has a C-shaped rotational shaft 74C that protrudes rightward from the right side portion 74. The rotational shaft 74C follows the entire circumference of the right side portion 74, excluding the insertion part 74B, and is arranged radially inward from the peripheral edge of the right side portion 74 toward the rotational axis 70A. The rotational shaft 74C engages in the rotary support 72A in the left surface of the right support part 72 and is rotatably supported in the right support part 72.

Unless otherwise specified, the following description will assume that the rotary body 70 is disposed in the initial position. The insertion parts 73B and 74B are positioned vertically below the affixable position P1 and downstream in the guiding direction Y4 from position P2 on the guiding path R4. The openings 732 and 742 in the respective insertion parts 73B and 74B are open toward the surface on the end of the label 160 disposed at the affixable position P1.

As shown in FIG. 3, the wrapping unit 7 has arm members 76 and 77, coil springs 78 and 79, and a support shaft 702, inside the rotary body 70. The arm members 76 and 77 grip and hold the cable 19 while the wrapping unit 7 wraps the label 160 around the same. The arm members 76 and 77 are metal members whose shapes are symmetrical to each other. The arm members 76 and 77 have respective gripping parts 76A and 77A, receiving parts 76B and 77B, bearing parts 76C and 77C, and spacers 76D and 77D. The gripping parts 76A and 77A are flat plates that extend in the left-right and up-down directions. The gripping parts 76A and 77A oppose each other in the front-rear direction with a gap between the gripping parts 76A and 77A.

The receiving parts 76B and 77B constitute the top portions of the respective arm members 76 and 77. The receiving parts 76B and 77B slope upward in an arc shape. The receiving parts 76B and 77B define an insertion opening 70B in the wrapping unit 7. The cable 19 is inserted into the insertion opening 70B together with the label 160.

The spacers 76D and 77D are disposed at positions on the corresponding gripping parts 76A and 77A that are closer to the bearing parts 76C and 77C than to the rotational axis 70A. Hence, by contacting each other, the spacers 76D and 77D maintain clearance between the gripping parts 76A and 77A. The bearing parts 76C and 77C are located on the same end sides of the corresponding gripping parts 76A and 77A in the vicinity of which the spacers 76D and 77D are located. The single support shaft 702 is inserted through the bearing parts 76C and 77C. Accordingly, the arm members 76 and 77 pivot around a common support shaft 702.

### Electrical Configuration

Next, the electrical configuration of the label wrapping device 1 will be described with reference to FIG. 6. The control unit 14 of the label wrapping device 1 includes a CPU 41, a ROM 42, a RAM 43, a flash memory 44, an input/output interface 45, drive circuits 196 and 197, and an external interface 47. The external interface 47 and the input/output interface 45 are respectively abbreviated “external IF 47” and “IO IF 45” in FIG. 6. The CPU 41, ROM 42, RAM 43, flash memory 44, and input/output interface 45 are interconnected via a data bus 46. The CPU 41 performs overall control of the label wrapping device 1.

The ROM 42 stores constants used by the CPU 41 when executing various programs. The RAM 43 stores temporary data generated by the CPU 41 when executing processes. The flash memory 44 stores programs executed by the CPU 41, and various data such as variables. The input/output interface 45 is connected to the notification part 13B, the operation part 13A, the drive circuits 196 and 197, sensors 181 through 187, and the external interface 47. The notification part 13B includes a plurality of LEDs capable of indicating the status of the label wrapping device 1. The notification part 13B also includes a tape replacement LED that illuminates when the tape cassette 100 is in a replaceable condition.

The operation part 13A includes buttons for operating the label wrapping device 1. The drive circuit 196 is an electronic circuit for driving motors 191 through 195. The drive circuit 197 is an electronic circuit for driving the thermal head 32. The external interface 47 is connected to and communicates with an external terminal device 300. For example, the CPU 41 can update programs stored in the flash memory 44 by overwriting the programs with programs received from the terminal device 300. The terminal device 300 is a general-purpose personal computer (PC) or a portable terminal.

The motor 191 is a DC motor for driving the wrapping unit 7. The motor 192 is a DC motor for driving the take-up unit 8. The motor 193 serves to drive the drive shaft 35 and take-up shaft 36 (FIG. 2). The motor 194 serves to drive the full-cut cutting blade 91. The motor 195 serves to drive the half-cut cutting blade 92.

As shown in FIG. 4, the sensor 181 is a microswitch capable of detecting whether the cable 19 is in the wrapping position P3 on the left end of the wrapping unit 7. The sensor 182 is a microswitch capable of detecting whether the cable 19 is in the wrapping position P3 on the right end of the wrapping unit 7. The rotary body sensor 183 is a transmissive photosensor for detecting the rotated position and number of rotations of the wrapping unit 7. The sensor 184 is a contact sensor for detecting whether the tape cassette 100 is mounted in the tape mounting unit 30. The sensor 185 includes a plurality of sensors for detecting the type of the tape cassette 100. The sensor 186 is a microswitch for detecting whether the movable blade of the full-cut cutting blade 91 is in its initial position. The sensor 187 is a microswitch for detecting whether the movable blade of the half-cut cutting blade 92 is in its initial position.

### Wrapping Modes

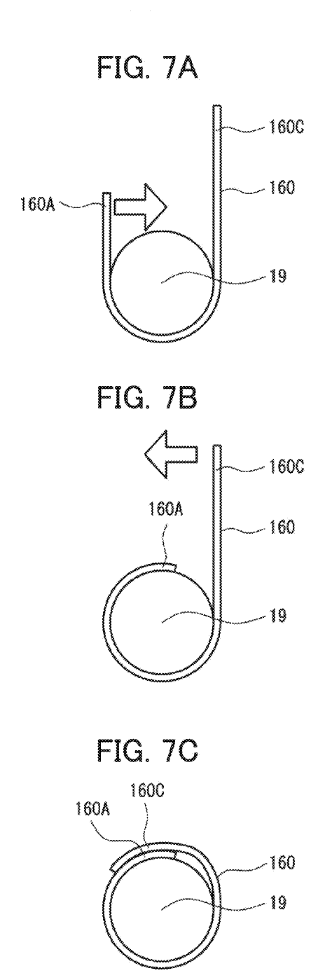

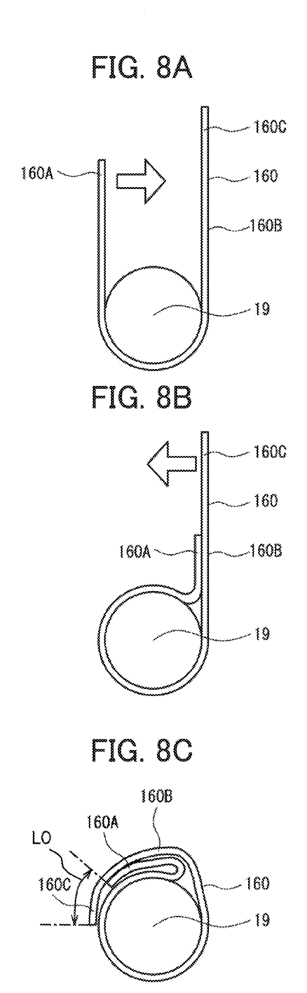

Next, wrapping modes executed by the label wrapping device 1 will be described with reference to FIGS. 7A-7C and 8A-8C. The label wrapping device 1 executes two wrapping modes: a first wrapping mode and a second wrapping mode. The first wrapping mode is used when the diameter of the cable 19 is greater than or equal to a prescribed value. An example of the prescribed value is 6 mm. The second wrapping mode is used when the diameter of the cable 19 is less than the prescribed value. When the diameter of the cable 19 is less than the prescribed value, the surface curvature of the cable 19 in the circumferential direction is greater. When the cable 19 has a large surface curvature, the label 160 is more likely to peel off the cable 19. In this case, the second wrapping mode is used. As will be described later, the second wrapping mode bonds the adhesive surface on one portion of the label 160 to the adhesive surface on another portion of the label 160 in order that the label 160 is less likely to peel off the cable 19. The second wrapping mode is also used when the cable 19 to which the label 160 is being attached is expected to be used for a relatively long period, such as over ten years, or when the surface of the cable 19 has a relatively low coefficient of friction. When the cable 19 is used for many years or when the surface of the cable 19 has a relatively low coefficient of friction, the label 160 attached to the cable 19 becomes more prone to peeling off. Therefore, the second wrapping mode is used to stick two portions on the adhesive surface of the label 160 together, reducing the likelihood of the label 160 peeling off the cable 19.

### First Wrapping Mode

FIGS. 7A through 7C illustrate the first wrapping mode. In the first wrapping mode, , as shown in FIG. 7A, the cable 19 is initially placed in contact with the adhesive surface of the label 160, which is the top surface, in an intermediate area between a trailing edge of the label 160 and a leading edge portion 160A of the label 160, where this intermediate area is offset slightly toward the trailing edge of the label 160 from the leading edge portion 160A of the label 160. As a result, the label 160 adheres to the cable 19. Next, the leading edge portion160A of the label 160 is affixed to the cable 19, as shown in FIG. 7B. Lastly, a trailing edge portion 160C of the label 160 is wrapped over and affixed to the top of the leading edge portion160A of the label 160 already affixed to the cable 19, as shown in FIG. 7C. The overlapping length of the label 160 is 5 mm, for example.

### Second Wrapping Mode

FIGS. 8A through 8C illustrate the second wrapping mode. In the second wrapping mode, as shown in FIG. 8A, the cable 19 is initially placed in contact with the adhesive surface of the label 160, which is the top surface, in an intermediate area between a trailing edge of the label 160 and a leading edge portion 160A of the label 160, where this intermediate area is offset toward the trailing edge of the label 160 from the leading edge portion 160A of the label 160. In the second mode, the leading edge portion160A has a length longer than in the first wrapping mode by a predetermined length. The predetermined length may be 2 mm, for example. Next, the adhesive surface on the leading edge portion160A of the label 160 is affixed to the adhesive surface on an intermediate portion 160B of the label 160 between the leading edge portion160A and trailing edge portion 160C, as shown in FIG. 8B. At this stage, the rear end of the leading edge portion160A is affixed to the cable 19. Lastly, the trailing edge portion 160C of the label 160 is wrapped over and affixed to the top of the label 160 already affixed to the cable 19, as shown in FIG. 8C. The length of overlap LO in the label 160 is 5 mm, for example. The second wrapping mode uses a wrapping method in which the label 160 is less likely to peel off the cable.

### Rotating Directions of the Rotary Body 70

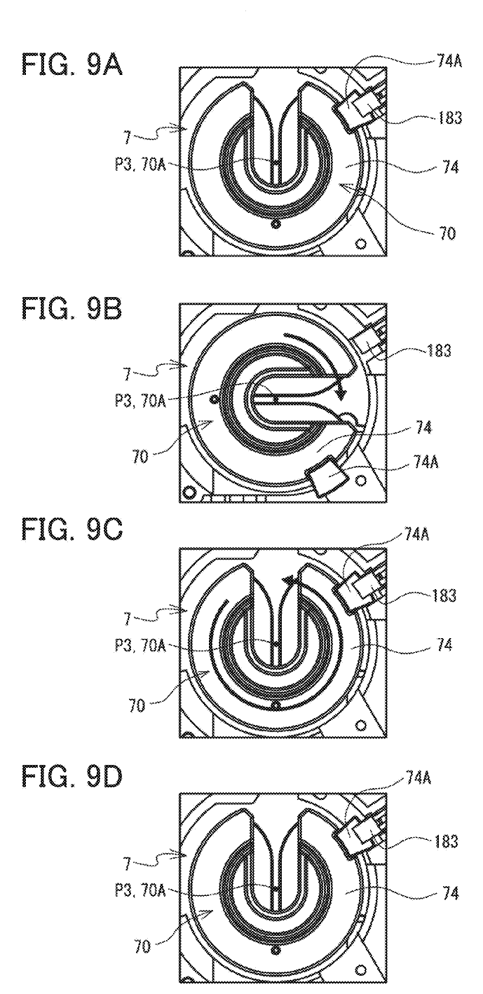

Next, the rotating directions of the rotary body 70 will be described with reference to FIGS. 9A-9D. The cable 19 has been omitted from the illustrations in FIGS. 9A-9D, but the cable 19 is actually located in the wrapping position P3 when a label wrapping process is performed. The position of the rotary body 70 shown in FIG. 9A is the initial position of the rotary body 70. The cable 19 is inserted into the rotary body 70 while the rotary body 70 is in the initial position shown in FIG. 9A. In the initial position of the rotary body 70, the detection plate 74A of the right side portion 74 is inside the rotary body sensor 183, as shown in FIG. 9A, turning the rotary body sensor 183 OFF. Clockwise rotation of the rotary body 70 illustrated in FIG. 9B is the reverse rotation of the rotary body 70. Counterclockwise rotation of the rotary body 70 illustrated in FIG. 9C is the forward rotation of the rotary body 70.

In the first wrapping mode described above, first the label 160 and cable 19 in the state shown in FIG. 7A are inserted into the rotary body 70 in the initial position shown in FIG. 9A. Next, the rotary body 70 is rotated in reverse, as illustrated in FIG. 9B. At this time, the leading edge portion160A of the label 160 becomes adhered to the cable 19, as shown in FIG. 7B. Next, the rotary body 70 is rotated forward, as illustrated in FIG. 9C. At this time, the trailing edge portion 160C of the label 160 overlaps and adheres to the leading edge portion160A of the label 160 already affixed to the cable 19, as shown in FIG. 7C. The cable 19 is then extracted from the rotary body 70 in the initial position shown in FIG. 9D.

In the second wrapping mode described above, first the label 160 and the cable 19 in the state shown in FIG. 8A are inserted into the rotary body 70 in the initial position shown in FIG. 9A. Next, the rotary body 70 is rotated forward, as illustrated in FIG. 9C. At this time, the adhesive surface on the leading edge portion160A of the label 160 becomes adhered to the adhesive surface on the intermediate portion 160B of the label 160, as shown in FIG. 8B. The rotary body 70 then continues to be rotated forward, as illustrated in FIG. 9C. At this time, the trailing edge portion 160C of the label 160 overlaps and adheres to the label 160 already affixed to the cable 19, as shown in FIG. 8C. The cable 19 is then extracted from the rotary body 70 in the initial position shown in FIG. 9D.

### Method of Calculating Label Length

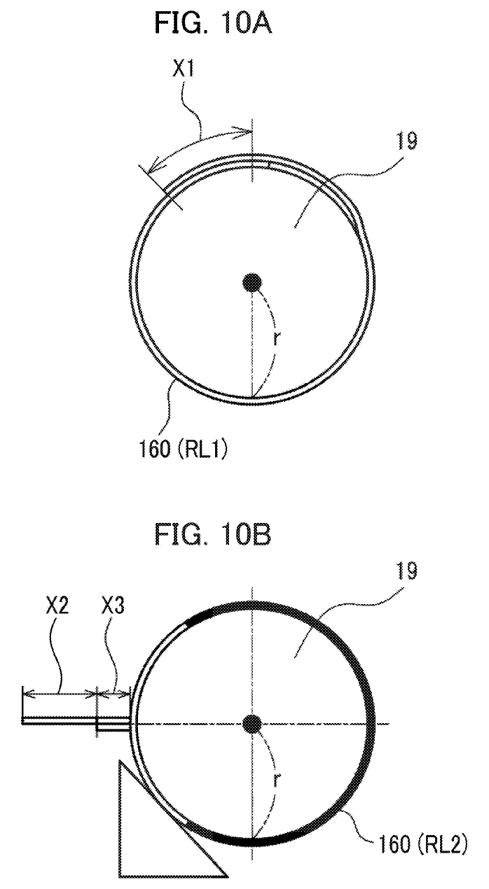

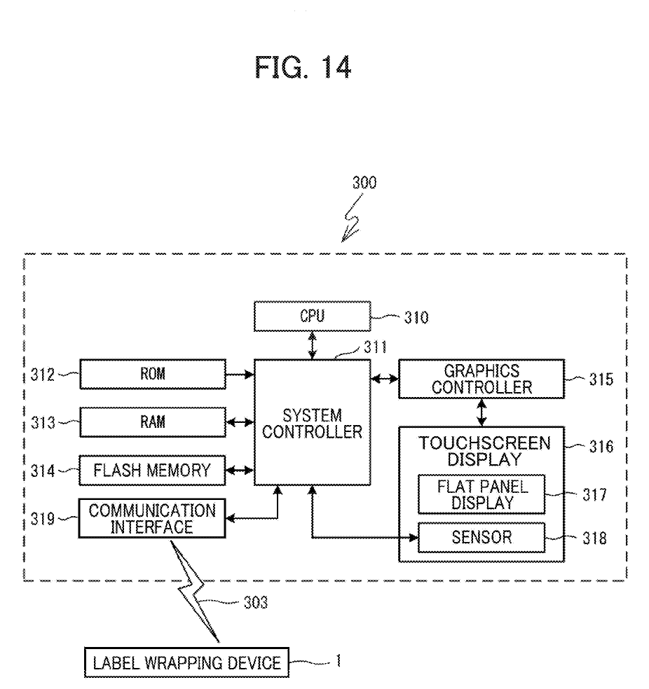

Next, a method of calculating the length of the label 160 will be described with reference to FIGS. 10A and 10B. The calculation method is executed by a CPU 310 (FIG. 14) of the terminal device 300 described later.

### First Wrapping Mode

First, a length RL1 of the label 160 wrapped around the cable 19 in the first wrapping mode will be described with reference to FIG. 10A. Let the radius of the cable 19 be “r” and the length of the overlapping portion of the label 160 be “X1”. The length RL1 of the label 160 used in the first wrapping mode is found using the following equation: RL1 = 2πr + X1.

### Second Wrapping Mode

Next, a length RL2 of the label 160 wrapped around the cable 19 in the second wrapping mode will be described with reference to FIG. 10B. Let the radius of the cable 19 be “r”, the length of the overlapped portion of the label 160 be “X2”, and the bonding length between two adhesive surfaces of the label 160 be “X3”. The length RL2 of the label 160 used in the second wrapping mode is found using the following equation: RL2 = 2πr + X2 + 2*X3.

Assuming that the radius “r” is the same in the first wrapping mode and the second wrapping mode, the inequality X2 + 2 * X3 > X1 holds true.

Therefore, the length RL2 of the label 160 used in the second wrapping mode is longer than the length RL1 of the label 160 used in the first wrapping mode. Consequently, the conveyed distance of the label 160 in the second wrapping mode is greater than the conveyed distance of the label 160 in the first wrapping mode. Further, the stopping position for the leading edge portion of the label 160, which is the edge on the downstream side in the conveying direction, is farther downstream in the conveying direction for the second wrapping mode than for the first wrapping mode.

### Method of Calculating a Label Extension

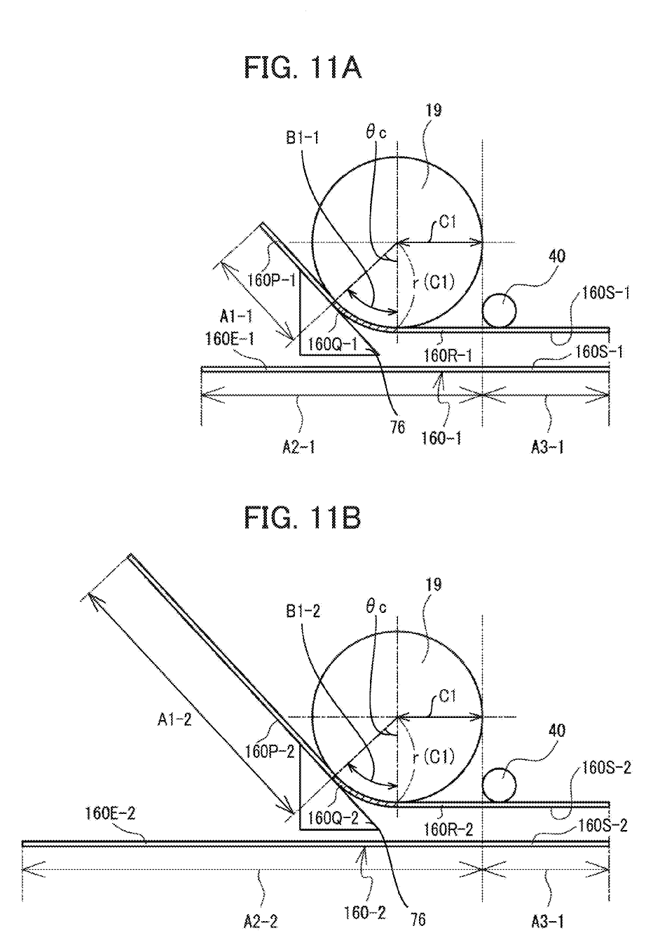

Next, a method of calculating a label extension will be described with reference to FIGS. 11A and 11B. FIG. 11A is a diagram illustrating the label extension when the radius of the cable 19 is “r” and the first wrapping mode is being performed. FIG. 11B is a diagram for illustrating the label extension when the radius of the cable 19 is “r” and the second wrapping mode is being performed.

FIGS. 11A and 11B are conceptual diagrams for illustrative purposes and may not reflect actual shapes, dimensions, or positional relationships of elements. Specifically, the arm member 76 is shown for the purpose of illustrating the state in which the arm member 76 is in contact with the label 160 if the cable 19 reaches the wrapping point P3 (FIG. 3) while the label 160 is partially adhered to the cable 19, and FIGS. 11A and 11B do not represent the actual position of the arm member 76.

As shown in FIGS. 11A and 11B, the portion of the label 160 conveyed past the peeling shaft 40 is a leading edge portion 160E. The leading edge portion 160E includes label segments 160P, 160Q, and 160R arranged in this order from the leading edge of the label 160. The label segment 160P is a segment that includes a leading edge of the label 160 and is not adhered to the cable 19 if the cable 19 reaches the wrapping position P3 while the label 160 is partially adhered to the cable 19. The label segment 160Q is a segment next to the label segment 160Q that is adhered to the cable 19 when the cable 19 reaches the wrapping position P3 while the label 160 is partially adhered to the cable 19. The label segment 160R is a segment next to the label segment 160Q that is not adhered to the cable 19 if the label 160 reaches the wrapping position P3 while the label 160 is partially adhered to the cable 19. The label 160 also includes a label segment 160S located next to the label segment 160R. In FIGS. 11A and 11B, the arm member 76 is depicted to show the state in which the label 160 is in contact with arm member 76 if the cable 19 reaches the wrapping position P3 while the label 160 is partially adhered to the cable 19. Here, when the cable 19 reaches the wrapping position P3, the arm member 76 pivots around the support shaft 702 (FIG. 3) such that the arm member 76 extends from the rear-lower side to the front-upper side. FIGS. 11A and 11B illustrates this posture of the arm member 76. In this state, although the actual label 160 is arranged to extend in the vertical direction, this condition is not reflected in FIGS. 11A and 11B.

A length A2 of the leading edge portion 160E is the “label extension.” Below, “-1” is appended to all reference numerals in the description of FIG. 11A and “-2” is appended to all reference numerals in the description of FIG. 11B.

As shown in FIG. 11A, the “length A2-1 of the label extension” is equal to the sum of the lengths of label segments 160P-1, 160Q-1, and 160R-1. The “length A1-1” of the label segment 160P-1 will be called the “leading edge excess length.” The label segment 160S-1 will be called the “trailing edge portion” of the label 160-1. The label segment 160S-1 has a length A3-1. As shown in FIG. 11B, the “length A2-2 of the label extension” is equal to the sum of the lengths of label segments 160P-2, 160Q-2, and 160R-2. The length A1-2 of the label segment 160P-2 will be called the “leading edge excess length.” The label segment 160S-2 will be called the “trailing edge portion” of the label 160-2. The label segment 160S-2 has a length A3-1.

The method of determining the length A2-1 of the label extension will be described next. The length of the label segment 160P-1 is the leading edge excess length A1-1. The leading edge excess length A1-1 set in the first wrapping mode differs from the leading edge excess length A1-2 set in the second wrapping mode. The leading edge excess length A1-1 is set such that when the rotary body 70 undergoes reverse rotation, the degree to which the leading edge portion of the label lifts off the cable 19 in the rotary body 70 is no greater than a prescribed length. The leading edge excess length A1-1 is a predetermined length, such as 5 mm. However, the leading edge excess length A1-1 may be set less than 5 mm or greater than 5 mm. Further, the leading edge excess length A1-1 may be a predetermined fixed value or may be variable based on the diameter of the cable 19. The leading edge excess length A1-1 may be variable that increases as the diameter of cable 19 increases. The label segment 160B-1 has an initial fixing length B1-1. The initial fixing length B1-1 is the length of an arc region extending from a point, at which the arm member 76 is in contact with the label 160 if the cable 160 reaches the wrapping position P3 while the label 160 is partially adhered to the cable 19, to the point directly below the center of the cable 19. The initial fixing length B1-1 may increase as the radius of the cable 1. In a case where a central angle θc of the arc region may not change significantly when the radius of the cable 19 changes, and thus, the initial fixing length B1-1 may increase in proportion to the radius of the cable 19. The length C1 is equal to the radius r of the cable 19 (C1 = r). However, the length C1 may slightly vary from the radius r. The length A2-1 of the label extension is found using the following equation.

A2-1 = A1-1 + B1-1 + C1

Next, the method of determining the length A2-2 of the label extension will be described. The length of the label segment 160P-2 is the leading edge excess length A1-2. The leading edge excess length A1-2 differs from the leading edge excess length A1-1. Specifically, the leading edge excess length A1-2 is greater than the leading edge excess length A1-1. The leading edge excess length A1-2 is set such that a length of X3 (FIG. 10B) on the leading edge side of the label is bonded to the trailing edge side of the label when the rotary body 70 is rotated forward. The leading edge excess length A1-2 is a predetermined length, such as 10 mm. However, the leading edge excess length A1-2 may be less than 10 mm or greater than 10 mm. Further, the leading edge excess length A1-2 may be a predetermined fixed value or may be variable based on the diameter of the cable 19. The leading edge excess length A1-2 may be variable that increases as the diameter of cable 19 increases. The label segment 160Q-2 has an initial fixing length B1-2. The initial fixing length B1-2 is the length an arc region extending from a point, at which the arm member 76 is in contact with the label 160 if the cable19 reaches the wrapping position P3 while the label 160 is partially adhered to the cable 19, to the point directly below the center of the cable 19. The initial fixing length B1-2 may increase as the radius of the cable 1. In a case where a central angle θc of the arc region may not change significantly when the radius of the cable 19 changes, and thus, the initial fixing length B1-2 increases in proportion to the radius of the cable 19. Note that the initial fixing lengths B1-1 and B1-2 are the same value for the same diameter of the cable 19. Here, the length C1 is equal to the radius r of the cable 19 (C1 = r). However, the length C1 may slightly vary from the radius r. The length A2-2 of the label extension is found using the following equation.

A2-2 = A1-2 + B1-2 + C1

In this embodiment, the stopping position for the leading edge of the label 160, which is the downstream edge of the label 160 in the conveying direction, may be rephrased as the position downstream of the peeling shaft 40 by the length of the label extension.

Hence, the length A2-2 of the label extension for the second wrapping mode is longer than the length A2-1 of the label extension for the first wrapping mode. Accordingly, the distance that the label 160 is conveyed in the second wrapping mode is greater than the distance that the label 160 is conveyed in the first wrapping mode. Further, the stopping position for the leading edge of the label 160, which is the downstream edge of the label 160 in the conveying direction, is farther downstream in the conveying direction for the second wrapping mode than the stopping position for the leading edge of the label 160 in the first wrapping mode.

### Determining the Label Length and Printing Position

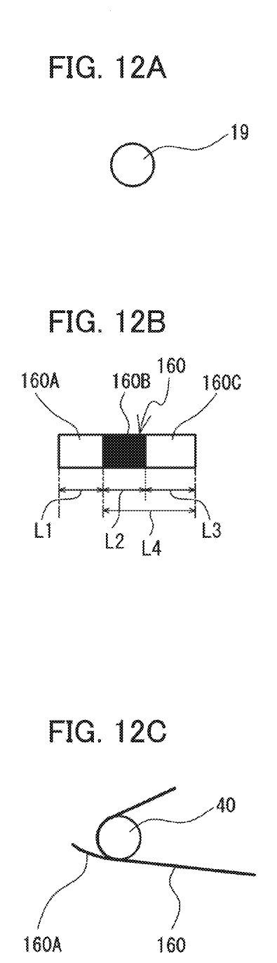

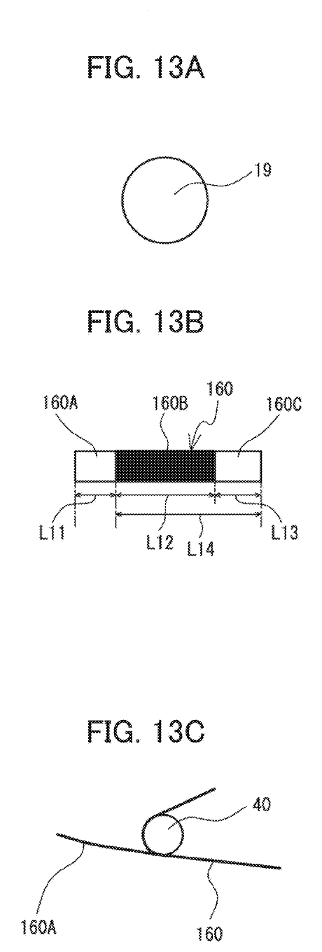

Next, a process executed by the CPU 41 to determine the label length and printing position will be described with reference to FIGS. 12A through 12C and 13A through 13C. Both the length of the label 160 and the position of the image being printed vary according to the diameter of the cable 19. FIGS. 12A through 12C and 13A through 13C are all illustrations on determining the label length and printing position in the first wrapping mode. FIGS. 12A through 12C show a case in which the diameter of the cable 19 is less than a prescribed value. The prescribed value is 6 mm, for example. In the label 160 shown in FIG. 12B, an area of the leading edge portion 160A is a non-printing area on the leading end of the label 160, and an area of the trailing edge portion 160C is a non-printing area on the trailing end portion of the label 160. The leading edge portion 160A is also referred to as the leading margin.

A sample length L1 of the leading edge portion 160A is 5 mm. However, the length L1 of the leading edge portion 160A may be less than 5 mm or greater than 5 mm. A sample length L3 of the trailing edge portion 160C is 2 mm. However, the length L3 of the trailing edge portion 160C may be less than 2 mm or greater than 2 mm. An area of the intermediate portion 160B is the printing area. A combined length L4 that includes a length L2 of the intermediate portion 160B and the length L3 of the trailing edge portion 160C is equal to the circumference of the cable 19 shown in FIG. 12A.

FIGS. 13A through 13C show a case in which the diameter of the cable 19 is greater than or equal to the prescribed value. The prescribed value is 6 mm, for example. In the label 160 shown in FIG. 13B, an area of the leading edge portion 160A is a non-printing area on the leading end portion of the label 160, and an area of the trailing edge portion 160C is a non-printing area on the trailing end portion. The leading edge portion 160A is also referred to as the leading margin.

A sample length L11 of the leading edge portion 160A is 5 mm. However, the length L11 of the leading edge portion 160A may be less than 5 mm or greater than 5 mm. A sample length L13 of the trailing edge portion 160C is 2 mm. However, the length L13 of the trailing edge portion 160C may be less than 2 mm or greater than 2 mm. An area of the intermediate portion 160B is the printing area. A combined length L14 that includes a length L12 of the intermediate portion 160B and the length L13 of the trailing edge portion 160C is equal to the circumference of the cable 19 shown in FIG. 13A. The cable 19 shown in FIGS. 13A and 13C has a larger diameter than the cable 19 shown in FIGS. 12A and 12C. In the case shown in FIG. 13C, the length of the label 160 over which the release material is peeled off is set longer in FIG. 13C than in the example of FIG. 12C. In other words, the position to which the label 160 is peeled from the leading edge of the label 160 is set farther toward the trailing edge side than the case shown in FIG. 12C.

The leading edge portion 160A having the non-printing area as shown in FIGS. 12B and 13B may be equivalent to the label segment 160P shown in FIGS. 11A and 11B. Alternatively, the length of the leading edge portion 160A may be determined based on the length of the label segment 160P. Moreover, the length of the leading edge portion 160A may be determined such that the length of the leading edge portion 160A increases as the length of the label segment 160P increase. Alternatively, both the length of the leading edge portion 160A and the length of the label segment 160P may be a fixed value irrespective of the diameter of the cable 19. The length of leading edge portion 160A may be determined independently of the length of the label segment 160P.

The area of the label 160 over which the release material is peeled off shown in FIGS. 12C and 13C may include all or a part of area of the intermediate portion 160B in addition to the leading edge portion 160A.

In the second wrapping mode, a sample length L1 of the leading edge portion 160A is 9 mm but may be longer or shorter than 9 mm. In the second wrapping mode, a sample length L11 of the leading edge portion 160A is 9 mm, but may be longer or shorter than 9 mm. In the second wrapping mode, the length L1 of the leading edge portion 160A is longer than that in the first wrapping mode. Similarly, In the second wrapping mode, the length L11 of the leading edge portion 160A is longer than that in the first wrapping mode.

### Terminal Device 300

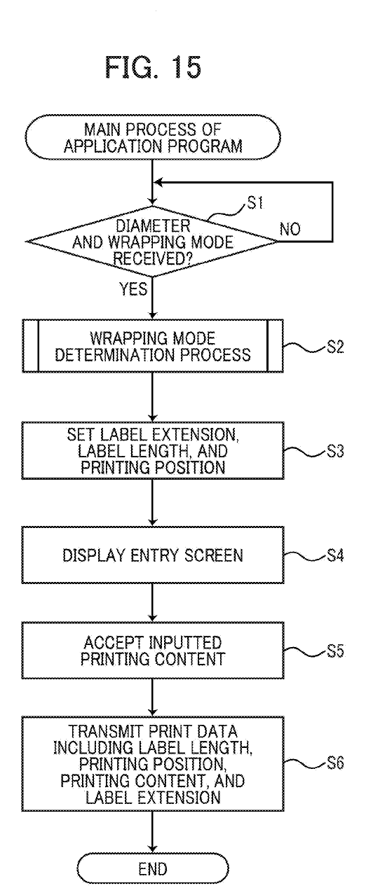

Next, the terminal device 300 will be described with reference to FIG. 14. The terminal device 300 executes the main process of an application program shown in FIG. 15. For example, the terminal device 300 is a portable information terminal device, such as a smartphone, a tablet device, a tablet computer, or a notebook computer. The terminal device 300 generates print data, transmits print data to the label wrapping device 1, and controls operations of the label wrapping device 1.

The terminal device 300 includes the CPU 310, a system controller 311, a ROM 312, a RAM 313, a flash memory 314, and a graphics controller 315. The terminal device 300 also includes with a touchscreen display 316, and a communication interface 319. The terminal device 300 may also include a keyboard.

The CPU 310 controls the terminal device 300. The CPU 310 executes the application program shown in FIG. 15. The system controller 311 connects a local bus of the CPU 310 to each component. The ROM 312 stores various data such as a BIOS, OS, and settings. The RAM 313 temporarily stores data generated when the CPU 310 executes processes. The flash memory 314 stores the programs executed by the CPU 310.

The touchscreen display 316 includes a flat panel display 317, and a sensor 318. The flat panel display 317 displays visual output for the user. The sensor 318 detects the contact position of a stylus pen or finger on the screen of the touchscreen display 316. The graphics controller 315 controls operations to display images on the flat panel display 317. The communication interface 319 is an interface capable of connecting to a network 303. The network 303 connects the terminal device 300 to the label wrapping device 1 via a wired or wireless connection.

### Main Process of the Application

A main process of the application program executed by the CPU 310 of the terminal device 300 will be described with reference to FIG. 15. The CPU 310 reads and executes an application program stored in the flash memory 314 to perform the main process. The CPU 310 displays a screen on the flat panel display 317 prompting the user to input the diameter of the cable 19 around which the label 160 is to be wrapped, and the wrapping mode. In S1 of FIG. 15, the CPU 310 determines whether the user has inputted the diameter of the cable 19 and either the first wrapping mode or second wrapping mode as the wrapping mode.

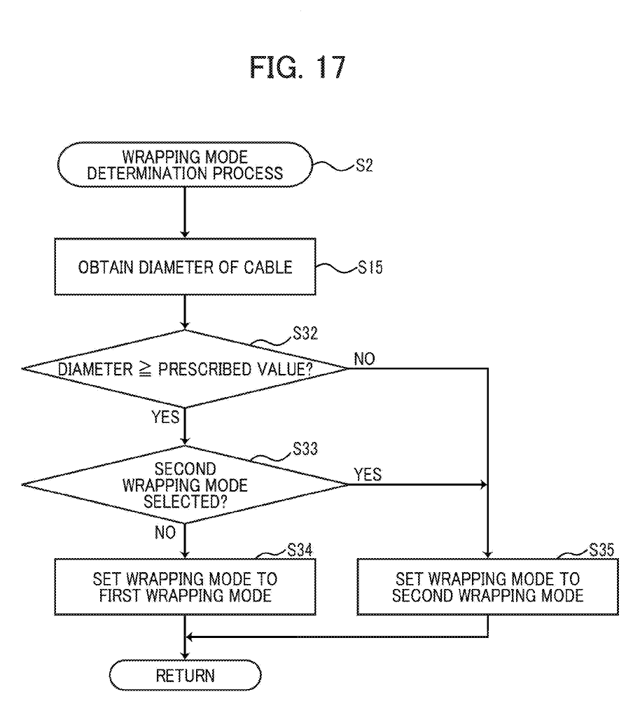

While the CPU 310 has not reached a YES determination in S1 (S1: NO), the CPU 310 continually repeats the determination in S1. Once the diameter of the cable 19 and the wrapping mode have been inputted (S1: YES), in S2 the CPU 310 performs a wrapping mode determination process shown in FIG. 17, which is executed by the CPU 310. In the wrapping mode determination process, the CPU 310 sets the wrapping mode and stores the set wrapping mode in the RAM 43. Note that the wrapping mode to be set in the wrapping mode determination process is not always the same as the wrapping mode inputted by the user in S1. A program for performing the wrapping mode determination process is stored in the flash memory 314. The CPU 310 reads and executes this program.

### Wrapping Mode Determination Process

The wrapping mode determination process executed by the CPU 310 of the terminal device 300 will be described with reference to FIG. 17. In S31 at the beginning of the process in FIG. 17, the CPU 310 obtains the diameter of the cable 19 inputted in S1 of the main process. In S32 the CPU 310 determines whether the diameter is greater than or equal to a prescribed value. An example of the prescribed value is 6 mm. When the diameter of the cable 19 is greater than or equal to the prescribed value (S32: YES), in S33 the CPU 310 determines whether the user selected the second wrapping mode. The CPU 310 performs the determination of S33 based on the wrapping mode inputted in S1 of the main process. In a case where the diameter of the cable 19 is less than the prescribed value (S32: NO), in S35 the CPU 310 sets the wrapping mode to the second wrapping mode.

In a case where the CPU 310 determines that the user has not selected the second wrapping mode (S33: NO), in S34 the CPU 310 sets the wrapping mode to the first wrapping mode because the first wrapping mode is sufficient when the diameter of the cable 19 is greater than or equal to the prescribed value (S32: YES). In a case where the CPU 310 determines that the user has selected the second wrapping mode (S33: YES), in S35 the CPU 310 sets the wrapping mode to the second wrapping mode in accordance with the user’s selection. Even when the diameter of the cable 19 is greater than or equal to the prescribed value, the second wrapping mode is suitable for using the cable 19 over a long period of ten years or more since the label 160 is less likely to peel off. Further, the second wrapping mode may be more suitable depending on the material and surface condition of the cable 19. Since the user may have selected the second wrapping mode in consideration of such a situation, when the second wrapping mode is designated by the user, the CPU 310 sets the second wrapping mode even when the inputted diameter is greater than or equal to the prescribed value. The CPU 310 then stores the wrapping mode set in S34 or S35 in the RAM 313, ends the wrapping mode determination process, and advances to S3 of the main process.

The CPU 310 may set the wrapping mode to the first wrapping mode when the diameter of the cable 19 is greater than or equal to the prescribed value and the second wrapping mode when the diameter is less than the prescribed value. Alternatively, the CPU 310 may determine the wrapping mode based on which of the first wrapping mode and second wrapping mode has been selected by the user, irrespective of the diameter of the cable 19. Alternatively, in S1 the CPU 310 may receive information on an expected service life of the cable 19 inputted by the user and the CPU 310 may determine whether to use the first wrapping mode or the second wrapping mode based on the expected service life of the cable 19 inputted by the user. For example, when the expected service life of the cable 19 is longer or equal to than a predetermined time period, the CPU 310 may set the wrapping mode to the second wrapping mode whereas when the expected service life of the cable 19 is shorter than the predetermined time period, the CPU 310 may set the wrapping mode to the first wrapping mode. Alternatively, in S1 the CPU 310 may receive information on material of the cable 19 inputted by the user and may determine whether to use the first wrapping mode or the second wrapping mode based on the material of the cable 19 inputted by the user. In this case, the CPU 310 may set the wrapping mode to the second wrapping mode when the material of the cable is of a specific type. The specific type may be a type of material whose coefficient of friction is lower than a predetermined value. Alternatively, the CPU 310 may receive information of a coefficient of friction of the cable 19 inputted by the user and may determine whether to use the first wrapping mode or the second wrapping mode based on the coefficient of friction of the cable 19. For example, when the coefficient is lower than a predetermined value, the CPU 310 may set the wrapping mode to the second wrapping mode.

In S3 the CPU 310 sets the label extension, label length, and printing position based on the diameter of the cable 19 and the wrapping mode set in S3. As described above, the CPU 310 sets the length of the label 160 in S3 longer for the second wrapping mode than for the first wrapping mode. As described above, the CPU 310 also sets the length of the label extension in S3 longer for the second wrapping mode than for the first wrapping mode. The CPU 310 may not perform calculations to determine any parameter of the label length, label extension, and printing position. For example, when the CPU 310 does not perform calculation to determine one of these parameters, data for a list containing values for the non-calculated parameter may be stored in the flash memory 314 in advance. Here, in the list, each combination of the diameter of the cable 19 and the wrapping mode is mapped to a corresponding value for the non-calculated parameter. In this case, the CPU 310 may determine and obtain the value of the non-calculated parameter based on the data of this list.

In S4 the CPU 310 displays an entry screen on the flat panel display 317 for inputting content such as characters to be printed. In S5 the CPU 310 accepts inputted printing content. For example, the CPU accepts the printing content by detecting a contact position of a finger or a stylus on the entry screen on the flat panel display 317. In S6 the CPU 310 transmits print data including information related to the label length, printing position, printing content, and label extension to the label wrapping device 1. The CPU 310 also sends the wrapping mode set in S2 to the label wrapping device 1 in S6. The information related to the printing position may indicate the printing area (the area of the intermediate portion 160B shown in FIGS. 12B and 13B) in the label 160. The information related to the printing position may indicate a position in the label 160 from which the printing is started. The information related to printing position may indicate the length of the non-printing area (the area of the leading edge portion 160A shown in FIGS. 12 and 13B) so that a printing start position (the leading edge of the printing area) can be specified based on this information. The information related to the label extension may indicate the length of the label extension. Or, the information related to the label extension may indicate a distance for conveying the label 160 that enables the label wrapping device 1 to convey the label 160 and stop the label 160 in such a manner that the leading edge of the label 160 at the stopping position. The distance may be a distance from a specific position of the label wrapping device 1 to the stopping position. The specific position may be the position of the peeling shaft 40 in the conveying direction, the position of the full-cut cutting blade 91 or half-cut cutting blade 92, or the position of the conveying roller 101.

Note that the CPU 310 may not transmit all or a part of the label length, label extension, and printing position to the label wrapping device 1. In this case, the CPU 41 of the label wrapping device 1 calculates non-transmitted parameter(s) of the label length, label extension, or printing position based on the wrapping mode and the diameter of the cable 19 in the same manner as S3. The diameter of the cable 19 may be obtained by a user operation through the operation part 13A. Alternatively, the CPU 41 may not perform calculations to determine the non-calculated parameter(s). In such a case, the CPU may obtain a value(s) of the non-calculated parameter(s) from a list. Here, the list may be stored in the flash memory 44 in advance. This list also contains values for the non-calculated parameter(s). Here, in the list, each combination of the diameter of the cable 19 and the wrapping mode is mapped to a corresponding value for the non-calculated parameter(s). In this case, the CPU 41 may select value(s) for the non-transmitted parameter(s) from the list based on the combination of the diameter of the cable 19 and the wrapping mode.

### Wrapping Process

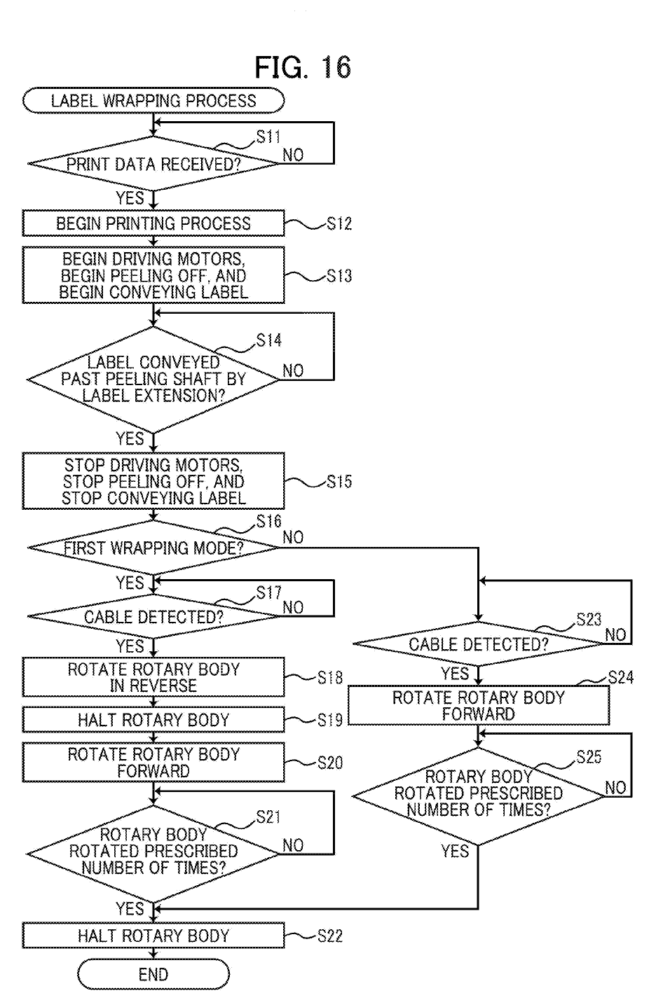

A label wrapping process executed by the CPU 41 of the label wrapping device 1 will be described with reference to FIG. 16. An application program for the main process is stored in the flash memory 44. The CPU 41 reads and executes this program. In S11 at the start of the main process, the CPU 41 determines whether print data has been received. The CPU 41 continually repeats the determination in S11 while a determination has not been made (S11: NO). When the print data is received (S11: YES), in S12 the CPU 41 begins the printing process. In S13 the CPU 41 begins driving the motors 192-194 and begins peeling off the label 160 and conveying the same.

The CPU 41 conveys the label 160 for a larger distance in the second wrapping mode than in the first wrapping mode. The stopping position for the leading edge of the label 160, which is the downstream edge in the conveying direction, is farther downstream in the conveying direction in the second wrapping mode than the stopping position in the first wrapping mode. The CPU 41 may set the conveying distance based on information included in the print data. The information used for setting the conveying distance may be the information related to the label extension included in the print data. The information used for setting the conveying distance may be the information related to the label extension included in the print data.

In S14 the CPU 41 determines whether the label 160 has been conveyed past the peeling shaft 40 by the label extension received from the application executed by the CPU 310 of the terminal device 300. The CPU 41 continually repeats the determination in S14 while not reaching a YES determination (S14: NO). Once the CPU 41 determines that the label 160 has been conveyed a distance equal to the label extension (S14: YES), in S15 the CPU 41 stops driving the motors 192-194 to stop peeling off and conveying the label 160 in S15.

In S16 the CPU 41 determines whether the label wrapping mode received from the application executed by the CPU 310 of the terminal device 300 is the first wrapping mode. When the CPU 41 determines that the wrapping mode is the first wrapping mode (S16: YES), the CPU 41 advances to S17. When the CPU 41 determines that the wrapping mode is not the first wrapping mode (S16: NO) but rather the second wrapping mode, the CPU 41 advances to S23.

Here, the process will be described for the case in which the CPU 41 determines the wrapping mode to be the first wrapping mode (S16: YES). In S17 the CPU 41 first determines whether the sensors 181 and 182 (FIG. 4) have detected the cable 19. The CPU 41 continually repeats the determination in S17 while not reaching a YES determination (S17: NO). Once the sensors 181 and 182 have detected the cable 19 (S17: YES), in S18 the CPU 41 rotates the rotary body 70 of the wrapping unit 7 in reverse, as shown in FIG. 9B. Subsequently, in S19 the CPU 41 halts the rotary body 70. In S20 the CPU 41 then rotates the rotary body 70 forward, as illustrated in FIG. 9C. In S21 the CPU 41 determines whether the rotary body 70 has rotated a prescribed first number of times based on the prescribed first number of detections of the detection plate 74A by the rotary body sensor 183.

The CPU 41 continually repeats the determination in S21 while not reaching a YES determination (S21: NO). When the rotary body sensor 183 has detected the detection plate 74A the prescribed first number of times and has determined that the rotary body 70 has rotated the prescribed first number of times (S21: YES), in S22 the CPU 41 halts the rotary body 70. One example of the prescribed first number of times is three rotations. Subsequently, the CPU 41 ends the label wrapping process.

Next, the process performed when the CPU 41 determines that the wrapping mode is not the first wrapping mode (S16: NO) will be described. In other words, a case of executing the second wrapping mode will be described. In S23 the CPU 41 first determines whether the sensors 181 and 182 have detected the cable 19. The CPU 41 continually repeats the determination in S23 while not reaching a YES determination (S23: NO). When the sensors 181 and 182 have detected the cable 19 (S23: YES), in S24 the CPU 41 rotates the rotary body 70 of the wrapping unit 7 forward, as illustrated in FIG. 9C. In other words, the CPU 41 does not rotate the rotary body 70 in reverse in the second wrapping mode.

In S25 the CPU 41 determines whether the rotary body 70 has rotated a prescribed second number of times based on the prescribed second number of detections of the detection plate 74A by the rotary body sensor 183. The CPU 41 continually repeats the determination in S25 while not reaching a YES determination (S25: NO). When the rotary body sensor 183 has detected the detection plate 74A the prescribed second number of times and has determined that the rotary body 70 has rotated the prescribed second number of times (S25: YES), in S22 the CPU 41 halts the rotary body 70. The prescribed first number of times may be different from or equal to the prescribed second number of times. One example of the prescribed second number of times is three rotations. Subsequently, the CPU 41 ends the label wrapping process.

The label wrapping device 1 has the arm member 76 (FIG. 3) that presses the downstream end of the label 160 against the cable 19 while the cable 19 is being inserted into the rotary body 70 of the wrapping unit 7. However, when the diameter of the cable 19 increases, a ratio of the length of the portion of the label 160 contacts the cable 19 at the wrapping position P3 to the circumference of the cable 19 may decrease if the stopping position for the leading edge of the label 160 is unchanged irrespectively of the diameter of the cable 19. As this ratio decreases, the adhesive force could become insufficient to allow the label 160 to adhere adequately to the cable 19 and thus the label 160 could drift toward the rotary body 70 without becoming sufficiently affixed to the cable 19. The label wrapping device 1 in the above embodiment resolves this problem.

In the embodiment described above, the CPU 41 of the label wrapping device 1 can modify the stopping position of the leading edge of the label 160, which is the downstream edge of the label 160 in the conveying direction, based on the diameter of the cable 19. Accordingly, the label wrapping device 1 can perform a wrapping process with the label 160 that is suitable for the diameter of the cable 19. This process can ensure a stable wrapping quality when the wrapping unit 7 performs operations to wrap the label 160 around the cable 19.

Let the stopping position for the leading edge of the label 160 on the support surface 62 when the diameter of the cable 19 is 6 mm or greater be called a first stopping position. FIG. 13C shows an example of the first stopping position. Let the stopping position for the leading edge of the label 160 on the support surface 62 when the diameter of the cable 19 is less than 6 mm be called a second stopping position. FIG. 12C shows an example of the second stopping position. With these stopping positions, a stable wrapping quality can be achieved when the wrapping unit 7 performs operations to wrap the label 160 around the cable 19.

Further, when the diameter of the cable 19 is 6 mm or greater, the CPU 41 controls the motor 193 such that the stopping position for the leading edge portion 160E-2 shown in FIG. 11B in the second wrapping mode is farther downstream in the conveying direction than the stopping position for the leading edge portion 160E-1 shown in FIG. 11A in the first wrapping mode. Accordingly, a stable wrapping quality can be achieved when the wrapping unit 7 performs operations to wrap the label 160 around the cable 19 by switching between the first wrapping mode and second wrapping mode according to the diameter of the cable 19.

The CPU 41 switches between the first wrapping mode and the second wrapping mode according to the diameter of the cable 19. Accordingly, a stable wrapping quality by the wrapping unit 7 wrapping the label 160 around the cable 19 can be achieved by switching between the first wrapping mode and second wrapping mode based on the diameter of the cable 19.

When the diameter of the cable 19 is 6 mm or greater, the CPU 41 performs a half-cut process on the tape 150 to generate a label having a first label length. When the diameter of the cable 19 is less than 6 mm, the CPU 41 performs a half-cut process on the label 160 to produce a label having a second label length. Accordingly, the length of the label 160 can be adjusted according to the diameter of the cable 19, even when performing a half-cut process on the label 160.

When the diameter of the cable 19 is 6 mm or greater, the CPU 41 executes a print that forms a margin on the downstream end of the label 160 having a length L11 in the conveying direction. When the diameter of the cable 19 is less than 6 mm, the CPU 41 executes a print that forms a margin on the downstream end of the label 160 having a length L1 in the conveying direction. Thus, the margin length can be adjusted according to the diameter of the target object such as a rod-shaped member. Accordingly, the label wrapping device 1 can adjust the margin length based on the diameter of the cable 19.

In the above embodiment, the cable 19 is an example of the target object. The conveying roller 101 is an example of the conveying roller. The wrapping unit 7 is an example of the wrapping assembly. The motor 193 is an example of the first driving member for driving the conveying roller. The motor 191 is an example of the second driving member for driving the wrapping assembly. The CPU 41 is an example of the controller. The insertion opening 70B is an example of the opening. The rotary body 70 is an example of the rotary body. The stopping position of the leading edge of the label 160 on the support surface 62 is an example of the stopping position. The diameter of the cable 19 greater than or equal to 6 mm is an example of the first dimension. The diameter of the cable 19 less than 6 is an example of the second dimension.

The stopping position of the leading edge of the label 160 on the support surface 62 when the diameter of the cable 19 is greater than or equal to 6 mm is an example of the first position. The stopping position of the leading edge of the label 160 on the support surface 62 when the diameter of the cable 19 is less than 6 mm is an example of the second position. The length of the label 160 is an example of the label length information. The label extension is an example of the position-related information and the distance information. When the diameter of the cable 19 is greater than or equal to 6 mm, each of the length of the label 160 and the label extension is an example of the first distance and the first value. When the diameter of the cable 19 is less than 6 mm, each of the length of the label 160 and the label extension is an example of the second distance and the second value.

The cutting unit 9 is an example of the cutter. The lengths L1 and L11 are examples of the margin information. The length L11 is an example of the first margin. The length L1 is an example of the second margin.

The non-printing area is an example of the non-printing region. The length of the non-printing area in the leading edge portions 160A shown in FIG. 12B is an example of the first margin length. The length of the non-printing area in the leading edge portions 160A shown in FIG. 13B is an example of the second margin length.

The operation part 13A is an example of the user interface. The CPU 310 is an example of the computer. The process of S6 is an example of the transmitting the position-related information, the transmitting the label length information, the transmitting the margin information, and the transmitting the mode information. The length of the label set when the diameter of the cable 19 is greater than or equal to 6 mm is an example of the first length. The length of the label set when the diameter of the cable 19 less than 6 mm is an example of the second length. The process of S2 is an example of the obtaining. The diameter of the cable 19 is an example of the dimension and diameter of the target object. The thermal head 32 is an example of the print head. The information indicating the first mode or the second mode is an example of the mode information.

### Variations of the Embodiment

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, a target object around which the label 160 is wrapped is not limited to the cable 19 but may also be any object that extends in an axial direction. An outer shape of the target object may be approximately circular in a cross section orthogonal to the axial direction. The target object may be a cylindrical member or a rod-shaped member such as a tool, or a writing instrument. A screwdriver is one example of a tool. Examples of writing instruments include pens and pencils. Further, the cable 19 is not limited to a diameter of 6 mm but may be 8 mm in diameter or even thicker. Similarly, the cable 19 is not limited to a diameter of 6 mm but may be as thin as 3 mm in diameter. Therefore, the prescribed value for the diameter of the cable 19, which serves as a reference for determining whether to use the first wrapping mode or the second wrapping mode, is not limited to 6 mm. This prescribed value can be adjusted based on the conditions of the cable 19.

The label wrapping device 1 may be configured to accept user input via the operation part 13A (FIG. 6) for diameter information specifying the diameter of the cable 19. The label wrapping device 1 may then transmit the diameter information received via the operation part 13A to the terminal device 300. In this case, the CPU 310 of the terminal device 300 can obtain diameter information specifying the diameter of the cable 19 from the label wrapping device 1 in the process of S2 described in FIG. 15. Alternatively, the label wrapping device 1 may perform the process in FIGS. 15 through 17 without the terminal device 300. In this case, the process in FIG. 15 may be performed in place of step S11 in FIG. 16. Here, rather than “sending” print data in S6 of FIG. 15, the label wrapping device 1 may “obtain” the print data. The label wrapping device 1 may include a reception unit such as a communication interface or a user interface for receiving inputted printing content.

In S6 of the main process performed through the application program, the CPU 310 transmits print data containing the label length, printing position, printing content, and label extension to the label wrapping device 1 all at once. However, the CPU 310 may send each piece of information to the label wrapping device 1 separately. Further, even when the CPU 41 of the label wrapping device 1 detects the trailing end of the film tape 110 in the tape cassette 100, the CPU 41 may continue printing, conveying, and wrapping labels without stopping while wrapping is still possible.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

The term “processor” encompasses both a single processor or a group of multiple processors located either locally or remotely working together or in a distributed fashion to collectively perform the tasks attributed to the “processor”. One or more processors may be referred to as a controller.

What is claimed is:

1. A label wrapping device comprising:
a conveying roller;
a wrapping assembly including a rotary body, the wrapping assembly defining an opening and an interior space continuous with the opening; and
a controller including one or more processors, the controller being configured to perform:
conveying a label in a conveying direction using the conveying roller;
stopping the conveying the label such that a downstream edge of the label in the conveying direction is located at a stopping position, the label crossing an object-insertion path in a state where the downstream edge is located at the stopping position, the object-insertion path extending to the opening; and
wrapping, after a target object has entered the interior space along the object-insertion path subsequent to the stopping, the label around the target object about a specific axis by rotating the rotary body,
wherein when a dimension of the target object in a transverse direction perpendicular to the specific axis is a first dimension, the stopping position is set to a first position whereas when the dimension of the target object is a second dimension different from the first dimension, the stopping position is set to a second position different from the first position.

2. The label wrapping device according to claim 1,
wherein the controller is configured to further perform:
obtaining position-related information related to the stopping position; and
setting the stopping position based on the position-related information.

3. The label wrapping device according to claim 2,
wherein when the dimension of the target object is the first dimension, the position-related information indicates a first distance for conveying the label whereas when the dimension of the target object is the second dimension, the position-related information indicates a second distance for conveying the label, the second distance being different from the first distance.

4. The label wrapping device according to claim 1,
wherein the controller performs the wrapping in either a first wrapping mode or a second wrapping mode,
wherein in the first wrapping mode, for wrapping the label around the target object, the controller rotates the rotary body in a forward direction and thereafter rotates the rotary body in a reverse direction,
wherein in the second wrapping mode, for wrapping the label around the target object, the controller rotates the rotary body in the forward direction but does not rotate the rotary body in the reverse direction.

5. The label wrapping device according to claim 4,
wherein when the dimension of the target object is a predetermined dimension, the stopping position is set to a third position in the first wrapping mode whereas the stopping position is set to a fourth position in the second wrapping mode, the fourth position being located downstream of the third position in the conveying direction.

6. The label wrapping device according to claim 4,
wherein the controller is configured to further perform:
switching between the first wrapping mode and the second wrapping mode based on the dimension of the target object.

7. The label wrapping device according to claim 1, further comprising:
a cutter,
wherein the controller is configured to further perform:
cutting, using the cutter, a main sheet to separate a portion of the main sheet to generate the label without cutting a release sheet laminated to the main sheet,
wherein when the dimension of the target object is the first dimension, the main sheet is cut such that the label has a first label length in the conveying direction whereas when the dimension of the target object is the second dimension, the main sheet is cut such that the label has a second label length in the conveying direction, the second label length being different from the first label length.

8. The label wrapping device according to claim 1, further comprising:
a print head,
wherein the controller is configured to further perform:
printing an image on a medium to generate the label,
wherein the printing is performed such that the label has a non-printing region at a downstream end portion of the label in the conveying direction,
wherein when the dimension of the target object is the first dimension, the non-printing region has a first length in the conveying direction whereas when the dimension of the target object is the second dimension, the non-printing region has a second length in the conveying direction, the second length being different from the first length.

9. The label wrapping device according to claim 1, further comprising:
a user interface configured to receive dimension information related to the dimension of the target object.

10. The label wrapping device according to claim 9,
wherein the controller is configured to further perform:
transmitting the dimension information to an information processing device.

11. The label wrapping device according to claim 1,
wherein the wrapping is started in a state where a portion of the label is adhered to the target object located in the interior space.

12. The label wrapping device according to claim 1,
wherein the target object has a circular cross section perpendicular to the specific axis,
wherein the dimension of the target object in the transverse direction is a diameter of the circular cross section.

13. A non-transitory computer-readable storage medium storing instructions for an information processing device communicable with a label wrapping device configured to wrap a label around a target object about a specific axis,
the instructions, when executed in the information processing device, causing the information processing device to perform:
obtaining dimension information related to a dimension of the target object in a transverse direction perpendicular to the specific axis; and
transmitting position-related information to the label wrapping device, the position-related information being set based on the dimension information, the position-related information being related to a stopping position, the position-related information being for use by the label wrapping device to stop conveyance of the label such that a downstream edge of the label in a conveying direction of the label is located at the stopping position,
wherein when the dimension of the target object is a first dimension, the position-related information includes a first value whereas when the dimension of the target object is a second dimension different from the first dimension, the position-related information includes a second value different from the first value.

14. The non-transitory computer-readable storage medium according to claim 13,
wherein the first value indicates a first distance for conveying the label and the second value indicates a second distance for conveying the label, the second distance being different from the first distance.

15. The non-transitory computer-readable storage medium according to claim 13,
wherein the instructions, when executed in the label wrapping device, cause the information processing device to further perform:
transmitting label length information to the label wrapping device, the label length information being set based on the dimension information, the label length information being related to a length of the label in the conveying direction,
wherein when the dimension of the target object is the first dimension, the label length information indicates a first length as the length of the label whereas when the dimension of the target object is the second dimension, the label length information indicates a second length as the length of the label, the second length being different from the first length.

16. The non-transitory computer-readable storage medium according to claim 13,
wherein the instructions, when executed in the label wrapping device, cause the information processing device to further perform:
transmitting margin information to the label wrapping device, the margin information being set based on the dimension information, the margin information being related to a length of a non-printing region in the conveying direction, the non-printing region being at a downstream end portion of the label in the conveying direction,
wherein when the dimension of the target object is the first dimension, the margin information indicates a first margin length as the length of the non-printing region whereas when the dimension of the target object is the second dimension, the margin information indicates a second margin length as the length of the non-printing region, the second margin length being different from the first margin length.

17. The non-transitory computer-readable storage medium according to claim 13,
wherein the instructions, when executed in the label wrapping device, cause the label wrapping device to further perform:
transmitting mode information to the label wrapping device, the mode information indicating either a first wrapping mode or a second wrapping mode,
wherein when the mode information indicating the first wrapping mode is transmitted to the label wrapping device, the label wrapping device wraps the label around the target object in the first wrapping mode in which, for wrapping the label around the target object, the label wrapping device rotates a rotary body of the label wrapping device in a forward direction and thereafter rotates the rotary body in a reverse direction,
wherein when the mode information indicating the second wrapping mode is transmitted to the label wrapping device, the label wrapping device wraps the label around the target object in the second wrapping mode in which, for wrapping the label around the target object, the label wrapping device rotates the rotary body in the forward direction, but does not rotate the rotary body in the reverse direction.

18. The non-transitory computer-readable storage medium according to claim 17,
wherein the instructions, when executed in the label wrapping device, cause the information processing device to further perform:
transmitting distance information to the label wrapping device, the distance information being related to a distance for conveying the label,
wherein when the dimension of the target object is a predetermined dimension, the distance information transmitted when the mode information indicates the first wrapping mode is different from the distance information transmitted when the mode information indicates the second wrapping mode.

19. The non-transitory computer-readable storage medium according to claim 13,
wherein the obtaining includes:
receiving the dimension information from the label wrapping device, the received dimension information being information inputted in the label wrapping device through a user interface of the label wrapping device.

20. A non-transitory computer-readable storage medium storing instructions for a label wrapping device,
the instructions, when executed in the label wrapping device, causing the label wrapping device to perform:
conveying a label in a conveying direction using a conveying roller of the label wrapping device;
stopping the conveying the label such that a downstream edge of the label in the conveying direction is located at a stopping position, the label crossing an object-insertion path in a state where the downstream edge is located at the stopping position, the object-insertion path extending to an opening of a wrapping assembly of the label wrapping device; and
wrapping, after a target object has entered an interior space of the wrapping assembly along the object-insertion path subsequent to the stopping, the label around the target object about a specific axis by rotating a rotary body of the wrapping assembly, the interior space being continuous with the opening,
wherein when a dimension of the target object in a transverse direction perpendicular to the specific axis is a first dimension, the stopping position is set to a first position whereas when the dimension of the target object is a second dimension different from the first dimension, the stopping position is set to a second position different from the first position.
